(19) United States
(12) Patent Application Publication
(10) Pub. No.: US 2020/0357280 A1
(43) Pub. Date: Nov. 12, 2020

(54) TRAFFIC CONTROL DEVICES, SYSTEMS, AND METHODS

(71) Applicant: RYG LIGHT, LLC, Solomons, MD (US)

(72) Inventor: Lowell CADE, Solomons, MD (US)

(21) Appl. No.: 16/939,673

(22) Filed: Jul. 27, 2020

Related U.S. Application Data
(63) Continuation-in-part of application No. 16/271,539, filed on Feb. 8, 2019, now Pat. No. 10,726,721.
(60) Provisional application No. 62/628,155, filed on Feb. 8, 2018.

(51) Int. Cl. G08G 1/0955; G08G 1/07; G06F 1/16; G06F 3/0488

(52) U.S. Cl. CPC G08G 1/0955; G08G 1/07; G06F 3/0488; G06F 1/1654; G06F 1/1692; G06F 1/1647

(57) ABSTRACT

A portable handheld traffic control device includes a lamp, a housing that encloses the lamp, and a handle. The handle attaches to a proximal (back) side of the housing and includes a control panel operable by a thumb of a hand grasping the handle. In a first (vehicle) mode, the lamp emits light on a distal (front) side of the housing in one of four colors: red, yellow, green, or white, when a respective button for the corresponding color is pressed. In a second (pedestrian) mode, pressing the red button causes the lamp to display a steady red upraised hand, pressing the yellow button causes the lamp to display a flashing red upraised hand, and pressing the green button causes the lamp to display a steady white walking person figure. A battery powers the lamp. The device includes a secondary display visible on the proximal (back) side of the device.

### CROSS REFERENCE TO RELATED APPLICATIONS

This application claims the benefit of U.S. patent application Ser. No. 16/271,539, entitled TRAFFIC CONTROL DEVICES, SYSTEMS, AND METHODS, filed on Feb. 8, 2019, and U.S. provisional patent application Ser. No. 62/628,155, entitled TRAFFIC CONTROL DEVICES, SYSTEMS, AND METHODS, filed on Feb. 8, 2018, the entire contents of which are incorporated herein by reference.

### BACKGROUND

Various devices, systems, and methods for controlling vehicle traffic are known. Various devices, systems, and methods for controlling pedestrian traffic are likewise known. In particular, vehicle and pedestrian traffic control signals (e.g., traffic lights and crosswalk signals) are known. For example, various standards, definitions, and specifications for such signals include those set forth in the “Manual on Uniform Traffic Control Devices” (MUTCD) of the United States Department of Transportation Federal Highway Administration. Other standards, definitions, and specifications include those set forth in the various publications of the Institute of Transportation Engineers (ITE), such as the “Vehicle Traffic Control Signal Heads” (VTCSH) standard, the “ITE LED Circular Signal Supplement” specification, the “VTCSH—Part 3: Light Emitting Diode (LED) Vehicle Arrow Signal Modules” specification, the “Pedestrian Traffic Control Signal Indications” (PTCSI) standard, and the “Pedestrian Traffic Control Signal Indicators-Light Emitting Diode (LED) Signal Modules” specification.

Dangerous conditions may arise when a traffic signal ceases to operate, such as may occur during a power outage. This may be especially so during inclement weather or at nighttime. In other situations, traffic signals are intentionally deactivated, such as during maintenance or during large-scale events (e.g., sporting events) to permit unusually large volumes of vehicle and/or pedestrian traffic to be accommodated. In these situations, and others, it may be desirable to have an alternative to permanently installed traffic signals.

### BRIEF SUMMARY

Devices, systems, and methods for public and private traffic control are disclosed.

An embodiment may serve as an emergency traffic control system, providing visual communication anywhere needed.

A portable handheld traffic control device comprises a lamp; a housing that encloses the lamp; a handle attached to a proximal side of the housing, the handle including a control panel operable to control emission by the lamp of light on a distal side of the housing; and a signal mode selector switchable between a first mode in which manual buttons of the control panel are configured to cause the lamp to display a first set of signals, and a second mode in which the manual buttons are configured to cause the lamp to display a second set of signals different from the first set. The handle is attached to the proximal side of the housing by an attachment portion that extends from the housing to a grip portion adapted to be grasped by a hand. The control panel is situated at an intersection of the attachment portion and the grip portion. The control panel is operable to control operation of the lamp. The control panel includes at least three color buttons arrayed in a sequence on the control panel and at least two pattern buttons arrayed on the control panel, each of the three color buttons and the two pattern buttons being operable by a thumb of a hand when grasping the handle. In indentation in the proximal side of the housing accommodates the fingers, for example, the knuckles, of a user's hand. The portable handheld traffic control device is configured to communicate with a computer. The device includes a video camera fixed to the housing, and the computer has a user interface configured to display a video stream received from the camera. The computer has a software user interface (UI) including a software control panel that mimics the shape, size, and arrangement of elements found on the control panel of the device.

Embodiments include a portable handheld traffic control light with three signals: red (stop), yellow (caution), and green (go). Some embodiments further include left and right turn signals. In some embodiments, the handheld traffic control light may emit a white light. In some embodiments, the signals are presentable alone or in combination to be emitted away from a surface of a lamp.

In some embodiments, the lamp has a circular profile. In some embodiments, the lamp is enclosed in a housing or case. In some embodiments, the housing includes a lens over the emitting side of the lamp housing, through which the lamp may emit light.

Some embodiments include a handle attached to the lamp housing. In some embodiments, the handle is attached to the lamp housing such that the lamp housing may be supported in use by a hand grasping the handle.

In some embodiments, the light is powered by one or more batteries. In some embodiments the batteries are rechargeable. In other embodiments, the batteries are disposable. In some embodiments, the handle encloses the batteries. In other embodiments, the batteries are distributed in other portions of the light. In still other embodiments, the batteries are distributed in the handle and in the housing. In still other embodiments, the batteries are distributed toward a bottom (gravity downward) end of the portable handheld traffic control device.

In some embodiments, the housing and/or the handle of the handheld traffic control light is made of a high impact plastic, combination of plastics, and/or combination of plastics and metal.

In some embodiments, the handheld traffic control light includes a sun shield above the lens.

In some embodiments, the handheld traffic control light includes a light source having at least one light-emitting diode (LED). Some embodiments include a plurality of LEDs arranged in an array. In some embodiments, the array includes one or more LEDs to emit light at a predetermined color, corresponding to a wavelength or range of wavelengths in the visible spectrum.

An embodiment includes a plurality of red light sources, a plurality of yellow light sources, and a plurality of green light sources. Other embodiments include a plurality of red light sources, green light sources, and blue light sources. In some embodiments, the intensity of red light, green light, and blue light may be varied to achieve one or more colors or shades, including white light. Other embodiments include at least one white light source.

A portable handheld traffic control device includes a handle attached to a rigid housing. The housing encloses a lamp. The handle is attached to a proximal surface of the housing. The handle includes a control panel having manual interface elements to permit a user to (1) turn the lamp on and off, (2) select a color for the lamp to emit, (3) select a pattern for the lamp to emit.

The manual interface elements include a switch to turn the lamp on and off; a lantern button to activate a white lamp color; a red button to activate a red lamp color; a yellow button to activate a yellow lamp color; a green button to activate a green lamp color; a left-hand arrow button to activate an arrow pointing toward the user's left-hand side; and a right-hand arrow button to activate an arrow pointing toward the user's right-hand side.

The control panel is integral to a surface angled away from a user's body when held in a user's hand, such that when held in a user's hand, the control panel is proximal to user's thumb on the hand that grasps the handle.

The portable handheld traffic control device is operable using a single hand, either right or left, without need of the other hand. The manual interface elements can be manipulated by the thumb of the hand that grasps the handle.

The handle includes an ergonomic grip to facilitate comfort even during extended use. With the weight of batteries or other heavy components in, near, or below the handle, the center of gravity may be optimized such that mechanical moments (corresponding to torques) and resulting discomfort in a user's hand are minimal. For example, a police officer holding the handle for an extended period, as may be necessary during a power outage that disables a fixed roadside traffic signal.

A sun shield obstructs light that would otherwise be incident on the lens. The sun shield has an arcuate shape substantially concentric to the lens and extending away from the handle. The sun shield is made of a rugged plastic, plastic composite, metal, or the like.

Viewed from the front, the portable handheld traffic control device includes an array of light sources extending in a vertical direction and in a horizontal direction. The light sources are packed in a hexagonal “honeycomb” packing arrangement. The number of light sources is on the order of approximately 1,000. Accordingly, a degree of granularity in the individual points of light emitted is achieved sufficient to define various arrangements, including distinguishable left and right-hand arrows.

In an embodiment, light sources of differing colors are packed together in sufficiently close proximity to achieve dithering, i.e., mixing of colors when viewed from an appropriate distance from the light sources. In another embodiment, one or more of the light sources is capable of emitting light at variable wavelengths corresponding to discretely discernible colors, e.g., red, yellow, and green.

Advantageously, it is not necessary to manually place or remove filters to achieve the varying combinations of colors and/or patterns to be displayed by the light. In some embodiments, the light sources are controllable via a controller (e.g., an analog control board, a digital microcontroller, a computer etc.) in response to inputs received from the control panel. In some embodiments, each of the light sources is independently controllable via the controller. In other embodiments, the controller addresses a plurality of like light sources via a common signal path or bus.

The portable handheld traffic control device operates on 12-Volt direct current (DC) power. In other embodiments, lower or higher voltage electrical power is employed, for example, 1.5-Volt, 3-Volt, 6-Volt, 9-Volt, or 24-Volt DC power. In some embodiments, the portable handheld traffic control device is operable by alternating current (AC) power, such as 120-Volt or 240-Volt power. The portable handheld traffic control device may be operated by plug-in power to an external power source, e.g., a battery pack, an electrical plug comprised in a motor vehicle, a three-prong wall outlet or the like.

The handle attaches to a proximal side of a back panel of the lamp housing. In some embodiments, the handle is formed integrally with the back panel. In some embodiments, the handle is separable. The portable handheld traffic control device may be stored with the handle removed from the back panel. The handle may comprise the power supply and may include electrical contacts at a surface adjoining the back panel, the back panel having corresponding electrical contacts to form electrical connections at the corresponding contacts. If a handle presently in use to power the lamp is running low on power, a freshly charged replacement handle may be swapped-in to replace the depleted handle, while minimizing downtime for the portable handheld traffic control device.

Viewed from the side, the lamp housing includes an indentation to accommodate the fingers and/or knuckles of a user's hands as they grip the handle. This can also have the benefit of improving forward-backward balance of the light, such that the portable handheld traffic control device tends to remain balanced in the user's hand, rather than tipping forward or backward.

The rear panel includes attachment points to connect the rear panel to the proximal side of the housing. Each attachment point comprises a fastener, such as a machine screw, inserted through a corresponding hole into a threaded portion of the lamp housing. In some embodiments, the handle, the rear panel, the attachment points, and/or the housing includes weatherproofing, such as o-ring seals, overlapping flanges, or the like, to prevent or reduce ingress of moisture, dirt, or other substances that could degrade the electrical and/or electronic components housed in the lamp housing.

In an embodiment, one or both of the lamp housing and the handle are made by injection molding. In some embodiments, the housing and/or the handle is made of a black material. In other embodiments, the housing and/or the handle is made of a yellow material. In other embodiment, the housing and/or the handle is painted. The colors of material by which the housing and/or the handle may be constructed are not limited.

In an embodiment, the lamp comprises a high-density LED board, having on the order of greater than 10 LEDs per inch or even 100 LEDs per inch.

In various embodiments, the portable handheld traffic control device has an overall size of from 3 to 5 inches width by 3 to 5 inches height, by 3 to 5 inches depth. In other embodiments, the portable handheld traffic control device has an overall size of from 4 to 10 inches in each of width, height, and depth. In other embodiments, the portable handheld traffic control device has an overall size of from 9 to 24 inches in each of width, height, and depth. In some embodiments, the portable handheld traffic control device has an overall front-to-back depth of 3 to 8 inches, an overall height from top to bottom of 12 to 30 inches, and an overall width of from 8 to 24 inches. According to various embodiments, the portable handheld traffic control device may be substantially taller than it is wide, or vice-versa.

In some embodiments, the portable handheld traffic control device has a strobe light mode that can be activated from the control panel by pressing a strobe button. Alternatively, the strobe light mode is activated by a combination of buttons presses and/or duration of press on another button.

In some embodiments, the buttons, or other manual interface portions of the control panel include backlighting. The buttons can remain visible to a user operating the portable handheld traffic control device in a dark environment.

In some embodiments, a spacing between a gripping portion of the handle and the lamp housing is adjustable. More space for gloves in bad weather or for bigger or hands (or less spaced, for smaller hands) of different users are easily and reliably accommodated. In an embodiment, the spacing adjusts by sliding the handle fore or aft in relation to the lamp housing. In another embodiment, the spacing adjusts by rotating the handle about a threaded axial extension. In other embodiments, other adjustment means may be employed.

Some embodiments have only two color-selection buttons, corresponding to green and red. Where a yellow (caution) button is not present, in some embodiments, the portable handheld traffic control device controller is not configured to emit yellow light. In other embodiments lacking a yellow (caution) button, the portable handheld traffic control device controller is configured to emit yellow light only in conjunction with another button press. For example, pressing the red button may activate a routine by which a yellow light is first emitted for an interval, after which a red light is displayed.

In some embodiments, one or more controls is variously activated and deactivated by a single, repeated manipulation. For example, a green button may be pushed on and then pushed off.

In another embodiment, when manipulating the red button, a first push turns on the red light, and a second push turns causes the yellow light to blink a first predetermined number of times (e.g., 3 times) in a predetermined time interval, after which the red light blinks a second predetermined number of times (e.g., 2 times), after which the red light shines continuously. In some embodiments, the controller includes predefined programs or routines defining sequences or patterns for the portable handheld traffic control device to display. In some embodiments, the controller's programs can be removed, updated, or replaced in whole or in part. In some embodiments, the controller is programmed via an external computer, over a data cable, or wirelessly. In other embodiments, the controller is programmed via an onboard user interface.

In some embodiments, the portable handheld traffic control device includes a double arrow button to activate display of arrows pointing in two different directions simultaneously. In some embodiments, rather than a double arrow button, two arrow buttons are independently controllable, so that one or the other or both can be displayed simultaneously by manipulating the two separate buttons.

Some embodiments include a battery level indicator to show by visual, auditory, or other means, a state of charge of one or more batteries.

Some embodiments include reflective portions on one or more portions of the portable handheld traffic control device. In an embodiment, reflecting strips are disposed on side profiles of the portable handheld traffic control device. Thus, a user of the portable handheld traffic control device may be visible to oncoming motorists approaching from the user's side, notwithstanding that the beam of light emitted from portable handheld traffic control device is not shining directly toward such oncoming motorists.

In some embodiments, the portable handheld traffic control device is adjustable to display pedestrian signals, such as a person walking and/or a hand. In other embodiments, the portable handheld traffic control device is adjustable to display a timer or counter, with numerals or other characters displayed at intervals.

Some embodiments include a hand loop, through which a user's wrist may be inserted. The loop may aid the user in supporting the light, and/or prevent the light from falling in the event the user loses his or her grip while holding the device.

Some embodiments include a clamp by which the portable handheld traffic control device may be removably attached to a fixed point, such as a belt loop on a user's clothing, a rack in a vehicle or in a building, or the like. In an embodiment, the clamp is on an upper portion of the portable handheld traffic control device. In another embodiment, the clamp is on the handle. In another embodiment, the clamp is on a central portion of the portable handheld traffic control device.

In an embodiment, the handle and the housing are arranged at an angle relative to one another such that the handle forms at least one leg of a tripod and a contact point on a bottom portion of the housing forms another leg of the tripod, whereby the portable handheld traffic control device rests in a standing position on a horizontal surface. According to various embodiments, the horizontal surface may be the ground, may be comprised in an exterior body surface of a vehicle, such as the roof of a car, or another surface.

In some embodiments, the handle and housing are adjustable to form a stand. In other embodiments, one or both of the handle and the housing includes a rigid attachment point by which the portable handheld traffic control device may be fixed to a stand. In some embodiments, the stand is a tripod.

In some embodiments, the portable handheld traffic control device is controllable remotely, either by wired or wireless connection. A wireless connection may be a Bluetooth connection, Wi-Fi, a cellular connection, or the like. A wired or wireless connection may be formed as part of a larger network, or as part of a limited point-to-point connection. In the case of a wireless connection, the portable handheld traffic control device's various colors and/or patterns may be operated by a computer interface, e.g., by a user on a smartphone, tablet, personal computer, wearable device, or the like. In an embodiment, the remote connection is mediated by a web server comprised in the portable handheld traffic control device while the remote interface is displayed in a web browser. In another embodiment, the remote interface is displayed in a local application running on the user's device. The connection may be secured by requiring a username and password, biometrically, and/or by other means known or hereafter developed in the relevant fields.

In still other embodiments, the lamp body is powered separately from the handle and the handle communicates by wired or wireless connection with the lamp body. Thus, the lamp body may be positioned at a location distant from the user, e.g., outside a user's vehicle, while the user operates the lamp body, e.g., inside the user's vehicle.

Aspect 1. According to a first aspect, a portable handheld traffic control device comprises a lamp; a housing that encloses the lamp; a handle attached to a proximal side of the housing, the handle including a control panel operable to control emission by the lamp of light on a distal side of the housing; and a signal mode selector switchable between a first mode in which manual buttons of the control panel are configured to cause the lamp to display a first set of signals, and a second mode in which the manual buttons are configured to cause the lamp to display a second set of signals different from the first set.

1.1 In another aspect of Aspect 1, a first set of signals includes a first pattern, a second pattern different from the first pattern, and a third pattern different from the first and second patterns, wherein the manual buttons of the control panel include a first pattern button operable to cause the lamp to emit light in the first pattern and a second pattern button operable to cause the lamp to emit light in the second pattern.

1.1.1 In any of the above aspects, the manual buttons of the control panel may further include a first color button operable in the first mode to cause the lamp to emit light of a first color, and a second color button operable in the first mode to cause the lamp to emit light of a second color different from the first color.

1.1.1.1 In any of the above aspects, the first color button may be further operable in the second mode to cause the lamp to display a first signal of the second mode, the first signal of the second mode having at least one of a color different from the first color of the first mode, and a shape different from the first, second, and third patterns of the first mode.

1.1.1.1.1 In any of the above aspects, the second color button may be further operable in the second mode to cause the lamp to display a second signal of the second mode, the second signal of the second mode having at least one of a color different from the second color of the first mode, and a shape different from the first, second, and third patterns of the first mode.

1.1.2 In any of the above aspects, the control panel may further include a third color button operable in the first mode to cause the lamp to emit light of a third color different from the first and second colors.

1.1.2.1 In any of the above aspects, the third color button may be operable in the second mode to cause the lamp to display a third signal of the second mode, the third signal of the second mode having at least one of a color different from the third color of the first mode, and a shape different from the first, second, and third patterns of the first mode.

1.1.2.2 In any of the above aspects, the control panel further may include a fourth color button operable in the first mode to cause the lamp to emit light of a fourth color different from the first, second, and third colors.

1.1.3 In any of the above aspects, the first pattern may be a right turn arrow and the second pattern may be a left turn arrow.

1.1.3.1 In any of the above aspects, the third pattern may be a circle.

1.2 In any of the above aspects, the first set of signals may include a steady red color, a steady yellow color, and a steady green color.

1.2.1 In any of the above aspects, the first set of signals further may include a steady white color.

1.3 In any of the above aspects, the second set of signals may include a steady red color, a flashing red color, and a steady white color.

1.4 In any of the above aspects, the second set of signals may include a steady red upraised hand; a flashing red upraised hand; and a steady white walking person.

1.5 In any of the above aspects, the control panel may include the signal mode selector.

1.6 In any of the above aspects, the control panel may include a power switch operable to connect and disconnect a power supply to the device.

1.7 In any of the above aspects, the control panel may be operable by a thumb of a hand grasping the handle.

1.8 In any of the above aspects, the device may further include an indentation on the proximal side of the housing adapted to accommodate a finger or knuckle of a hand grasping the handle.

1.9 In any of the above aspects, the device may further include a feedback window on the proximal side of the housing, the feedback window being configured to display responses corresponding to signals displayed by the lamp.

1.9.1 In any of the above aspects, the feedback window may include a plurality of light sources arrayed between left and right-hand sides of the distal side of the housing

1.9.2 In any of the above aspects, the light sources may include light-emitting diodes.

1.10 In any of the above aspects, the device may further comprise a video camera fixed to the housing.

1.10.1 In any of the above aspects, the device may further include a controller configured to capture a video stream received by the video camera.

1.10.1.1 In any of the above aspects, the controller may be further configured to encode the video stream and to communicate the video stream to a remote device by a network connection.

Aspect 2. According to a second aspect, which may be combined with any of the above aspects, a non-transitory computer-readable medium may store instructions to configure a controller to perform a method comprising: receiving a change in a state of a signal mode selector of a traffic control device, and when the signal mode selector state changes, updating a state of a lamp of the traffic control device and updating a state of a feedback window of the traffic control device; receiving a change in a state of a color selector of the traffic control device, and when the color state changes, updating a state of the lamp and updating a state of the feedback window; receiving a change in a state of a pattern selector of the traffic control device, and when the pattern state changes, updating a state of the lamp and updating the state of the feedback window.

Aspect 3. According to a third aspect, which may be combined with any of the above aspects, a system may comprise a portable handheld traffic control device in communication with a computer, the traffic control device having a camera, the computer having a user interface to display a video stream received from the camera.

3.1 In any of the above aspects, the computer may be a mobile device.

3.2 In any of the above aspects, the user interface may include a touchscreen.

3.3 In any of the above aspects, the user interface may include a control panel having a signal mode selector, a first color button, a second color button, a third color button, a first pattern button, and a second pattern button, the signal mode selector located toward a bottom of the control panel, the first, second, and third color buttons arrayed above the signal mode selector and extending between right and left-hand sides of the control panel, and the first and second pattern buttons arrayed above the first, second, and third color buttons and extending between right and left-hand sides of the control panel.

3.3.1 In any of the above aspects, the control panel further may comprise a fourth color button located above the signal mode selector and below the first, second, and third color buttons.

3.3.2 In any of the above aspects, the control panel further may comprise a third pattern button located between the first and second pattern buttons.

Aspect 4. According to a fourth aspect, which may be combined with any of the above aspects, a portable handheld traffic control device may comprise: a lamp; a housing that encloses the lamp; a handle attached to a proximal side of the housing, the handle including a control panel operable to control emission by the lamp of light on a distal side of the housing; and an indentation on the proximal side of the housing adapted to accommodate a finger or knuckle of a hand when grasping the handle.

4.1 In any of the above aspects, the control panel further may be integral to a surface angled toward the proximal side of the housing.

4.2 In any of the above aspects, the center of gravity of the device may be below a top edge of the hand when grasping the handle.

4.3 In any of the above aspects, the device may comprise a battery compartment located below the center of gravity of the device.

Aspect 5. According to another aspect of the technology, which may be combined with any of the above aspects, a portable handheld traffic control device may include a mount point adapted for mounting the device on a tripod.

Aspect 6. According to another aspect of the technology, which may be combined with any of the above aspects, in a handle for a portable handheld traffic control device, the handle may comprise a grip portion that extends along an axis; a control panel support surface on a proximal side of the handle; a display support surface on a distal side of the handle; and a control panel attachment device to removably connect a control interface device to the control panel support surface such that the control interface device, when connected to the control panel support surface, is operable by a thumb of a hand that, when the handle is in use, grasps the grip portion by at least one of a finger and a palm of the hand.

6.1 According to another aspect of the technology, which may be combined with any of the above aspects, a control interface device connected to the control panel support surface.

6.1.1 According to another aspect of the technology, which may be combined with any of the above aspects, a control interface device includes a mobile device having a touchscreen.

6.1.2 According to another aspect of the technology, which may be combined with any of the above aspects, a display device is connected to a display support surface.

6.1.2.1 According to another aspect of the technology, which may be combined with any of the above aspects, a display device includes a second mobile device having a touchscreen.

6.1.2.2 According to another aspect of the technology, which may be combined with any of the above aspects, the control interface device communicates with the display device to control a signal presented by a lamp of the display device.

6.1.2.3 According to another aspect of the technology, which may be combined with any of the above aspects, the display device communicates with the control interface device to control a secondary display of the control interface device.

6.1.2.3.1 According to another aspect of the technology, which may be combined with any of the above aspects, the secondary display of the control interface device displays a representation of a signal simultaneously displayed by a lamp of the display device.

6.2 According to another aspect of the technology, which may be combined with any of the above aspects, portable handheld traffic control device includes a display attachment device to removably connect a display device to the display support surface.

6.2.1 According to another aspect of the technology, which may be combined with any of the above aspects, a portable handheld traffic control device includes: a handle; and a display device connected to the display support surface of the handle.

6.3 According to another aspect of the technology, which may be combined with any of the above aspects, a portable handheld traffic control device, comprises: the handle; a control interface device connected to the control panel support surface; and a display device connected to the display support surface.

6.4 According to another aspect of the technology, which may be combined with any of the above aspects, the control panel support surface is parallel to the longitudinal axis of the grip portion.

6.5 According to another aspect of the technology, which may be combined with any of the above aspects, the display support surface is parallel to the longitudinal axis of the grip portion.

6.6 According to another aspect of the technology, which may be combined with any of the above aspects, the control panel support surface is perpendicular to the longitudinal axis of the grip portion, and the display support surface is parallel to the longitudinal axis of the grip portion.

6.7 According to another aspect of the technology, which may be combined with any of the above aspects, the control panel support surface is parallel to the longitudinal axis of the grip portion and the display support surface is perpendicular to the longitudinal axis of the grip portion.

6.8 According to another aspect of the technology, which may be combined with any of the above aspects, the handle includes an adjustable display support member connected to the handle at a pivot point, the display support surface including a distal face of the display support member, whereby an angle of the display support surface relative to the longitudinal axis of the grip portion is variable by pivoting the display support member about the pivot point.

6.9 According to another aspect of the technology, which may be combined with any of the above aspects, the handle includes the control panel support surface is angled by an angle relative to the longitudinal axis of the grip portion, and the display support surface is parallel to the longitudinal axis of the grip portion.

6.10 According to another aspect of the technology, which may be combined with any of the above aspects, the handle includes an attachment portion that extends from the distal side of the handle to the display support surface, the display support surface being spaced apart from the grip portion by the attachment portion.

6.10.1 According to another aspect of the technology, which may be combined with any of the above aspects, the control panel support surface forms an angle relative to the axis of the grip portion.

Aspect 7. According to another aspect of the technology, which may be combined with any of the above aspects, in a handle for a portable handheld traffic control device, the handle comprises: a grip portion that extends along an axis; a control panel operable by a thumb of a hand that, when the handle is in use, grasps the grip portion between at least one finger and the palm of the hand; a display support surface on a distal side of the handle; and a display attachment device to removably connect a display device to the display support surface.

7.1 According to another aspect of the technology, which may be combined with any of the above aspects, a portable handheld traffic control device, comprises: the handle; and a display device connected to the display support surface.

7.1.1 According to another aspect of the technology, which may be combined with any of the above aspects, the display device includes a second mobile device having a touchscreen.

Aspect 8. According to another aspect of the technology, which may be combined with any of the above aspects, a method of signaling to oncoming traffic comprises: grasping a grip portion of a portable handheld traffic control device between at least one finger and a palm of a hand, the portable handheld traffic control device including a control interface device having a plurality of interface elements; and, while grasping the grip portion between the finger and palm: abducting the thumb of the hand away from the palm to contact an interface element positioned toward a medial edge of the control interface device; adducting the thumb of the hand to contact an interface element positioned toward a lateral edge of the control interface device; extending the thumb of the hand to contact an interface element positioned toward a distal edge of the control interface device; and flexing the thumb of the hand to contact an interface element positioned toward a proximal edge of the control interface device.

8.1 According to another aspect of the technology, which may be combined with any of the above aspects, the plurality of interface elements includes at least one manual interface element.

8.2 According to another aspect of the technology, which may be combined with any of the above aspects, the plurality of interface elements includes at least one touchscreen interface element.

8.2.1 According to another aspect of the technology, which may be combined with any of the above aspects, the control interface device includes a touchscreen of a mobile device, and the method further comprises: displaying the touchscreen interface element on the touchscreen of a mobile device.

Aspect 9. According to another aspect of the technology, which may be combined with any of the above aspects, a method of signaling to oncoming traffic comprises: grasping a grip portion of a portable handheld traffic control device between at least one finger and a palm of a hand, the portable handheld traffic control device including a control interface device having a plurality of interface elements; and, while grasping the grip portion between the finger and palm: abducting the thumb of the hand away from the palm to contact an interface element positioned toward a medial edge of the control interface device; adducting the thumb of the hand to contact an interface element positioned toward a lateral edge of the control interface device; extending the thumb of the hand to contact an interface element positioned toward a distal edge of the control interface device; and flexing the thumb of the hand to contact an interface element positioned toward a proximal edge of the control interface device.

9.1 According to another aspect of the technology, which may be combined with any of the above aspects, the plurality of interface elements includes at least one manual interface element.

19.2 According to another aspect of the technology, which may be combined with any of the above aspects, the plurality of interface elements includes at least one touchscreen interface element.

19.3 According to another aspect of the technology, which may be combined with any of the above aspects, the control interface device includes a touchscreen of a mobile device, the method further comprising: displaying the touchscreen interface element on the touchscreen of the mobile device.

### BRIEF DESCRIPTION OF DRAWINGS

The present technology is illustrated by way of example, and not by way of limitation, in the figures of the accompanying drawings, in which like reference numerals refer to similar elements, wherein:

FIG. 1 shows a side view of a device in use according to an embodiment;

FIG. 2 shows a side view of a device in use according to an embodiment;

FIG. 3 shows a front view of a device according to an embodiment;

FIG. 4 shows a front view of a device according to an embodiment;

FIG. 5 shows a back view of the device of FIG. 4;

FIG. 6 shows a detailed view of the device of FIGS. 4 and 5;

FIG. 7 shows a side view of a device according to FIGS. 4-6;

FIG. 8 shows a front view of a device according to an embodiment;

FIG. 9 shows a side view of the device of FIG. 8;

FIG. 10 shows a side view of a device according to an embodiment;

FIG. 11 shows a front view of the device of FIG. 10;

FIG. 12 shows a schematic view of a device according to an embodiment;

FIG. 13 shows a device according to an embodiment;

FIG. 14 shows a system according to an embodiment;

FIG. 15 shows a method according to an embodiment;

FIG. 16 shows a flowchart and resulting states for a method according to an embodiment;

FIG. 17 shows aspects of a method according to an embodiment;

FIG. 18 shows aspects of a method according to an embodiment;

FIG. 19 shows aspects of a method according to an embodiment;

FIG. 20A shows aspects of a method according to an embodiment;

FIG. 20B shows a system according to an embodiment;

FIG. 21 shows a system according to an embodiment;

FIG. 22 shows a system according to an embodiment;

FIG. 23 shows a device according to an embodiment;

FIG. 24 shows a side view of a device in use according to an embodiment;

FIG. 25 shows a back view of a device according to an embodiment;

FIG. 26 shows a back view of a device according to an embodiment;

FIG. 27 shows an exploded side view of a device according to an embodiment;

FIG. 28 shows a front view of a device according to an embodiment;

FIG. 29 shows an exploded partial cutaway side view of a device according to an embodiment;

FIG. 30 shows a front view of a device according to an embodiment;

FIG. 31 shows an exploded cutaway side view of a device according to an embodiment;

FIG. 32 shows a perspective view according to an embodiment;

FIG. 33 shows a perspective view according to an embodiment;

FIG. 34 shows a side view according to an embodiment;

FIG. 35 shows a side view according to an embodiment;

FIG. 36 shows a side view according to an embodiment;

FIG. 37 shows a side view according to an embodiment;

FIG. 38 shows a side view according to an embodiment;

FIG. 39 shows a side view according to an embodiment;

FIG. 40 shows a side view according to an embodiment;

FIG. 41 shows a side view according to an embodiment;

FIG. 42 shows a side view according to an embodiment;

FIG. 43 shows a perspective view according to an embodiment;

FIG. 44 shows a perspective view according to an embodiment;

FIG. 45 shows an exploded perspective view according to an embodiment;

FIG. 46 shows an exploded perspective view according to an embodiment;

FIG. 47 shows an exploded perspective view according to an embodiment; and

FIG. 48 shows an exploded perspective view according to an embodiment.

### DETAILED DESCRIPTION OF EMBODIMENTS

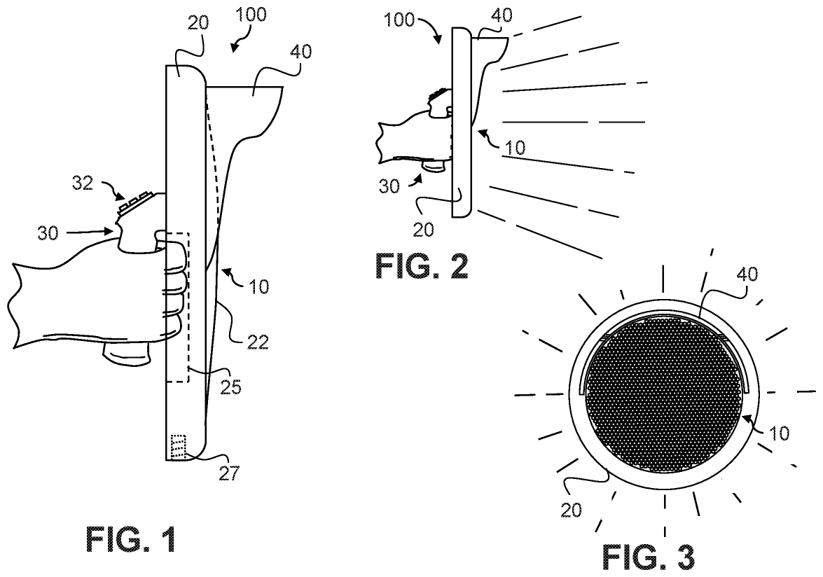

FIG. 1 shows a side view of a portable handheld traffic control device 100 in use according to a first embodiment. Embodiments include a portable handheld traffic control device 100 having three signal colors: red (stop), yellow (caution), and green (go). Some embodiments further include left and right turn signals. In some embodiments, the handheld traffic control device 100 also may emit white light. In some embodiments, the signals are presentable alone or in combination to be emitted away from a surface of a lamp 10.

The handheld traffic control device 100 includes the lamp 10. In some embodiments, the lamp 10 is enclosed in a housing 20. In some embodiments, the housing 20 includes a lens 22 over an emitting side of the housing 10, through which the lamp 10 shines when illuminated. Other embodiments omit the lens 22.

FIG. 2 shows a side view of the portable handheld traffic control device 100 in use. FIG. 2 shows light being emitted from the lamp 10. In FIG. 2 the lens 22 is omitted. Still other embodiments include multiple lenses. For example, where multiple light sources are provided, each may include its own lens.

FIG. 3 shows a front view of the portable handheld traffic control device 100 in use. FIG. 3 shows light being emitted from the lamp 10. In some embodiments, the lamp 10 has a circular profile. In other embodiments, the lamp 10 has a profile of a different shape, such as a square, a rectangle, a triangle, or an octagon. In an embodiment, the lamp 10 has a size and shape corresponding to a defined standard. For example, in some embodiments, the lamp 10 illuminates a circular shape having a diameter of 12 inches. In some embodiments, the lamp 10 has a diameter from 11.5 inches to 13 inches.

The handheld traffic control device 100 includes a handle 30 attached to the housing 20. In some embodiments, the handle 30 is attached to the lamp housing 20 such that the lamp housing 20 may be supported in use by a hand grasping the handle 30. In an embodiment, a control panel 32 is disposed on or near the handle 30.

In some embodiments, the handheld traffic control device 100 includes a sun shield 40 above the lamp 10 and/or above the lens 22. The sun shield 40 obstructs light that would otherwise be incident on the lamp 10 and/or the lens 22. The sun shield 40 has an arcuate shape substantially concentric to the lens 22 and extending away from the handle 30. The sun shield 40 in certain non-limiting embodiments is made of a rugged plastic, plastic composite, metal, or the like. In an embodiment, one or both of the lamp housing 20 and the handle 30 are made by injection molding. In some embodiments, the housing 20 and/or the handle 30 is made of a black material, a yellow material, or is painted. The colors of material by which the housing 20 and/or the handle 30 may be constructed are not limited.

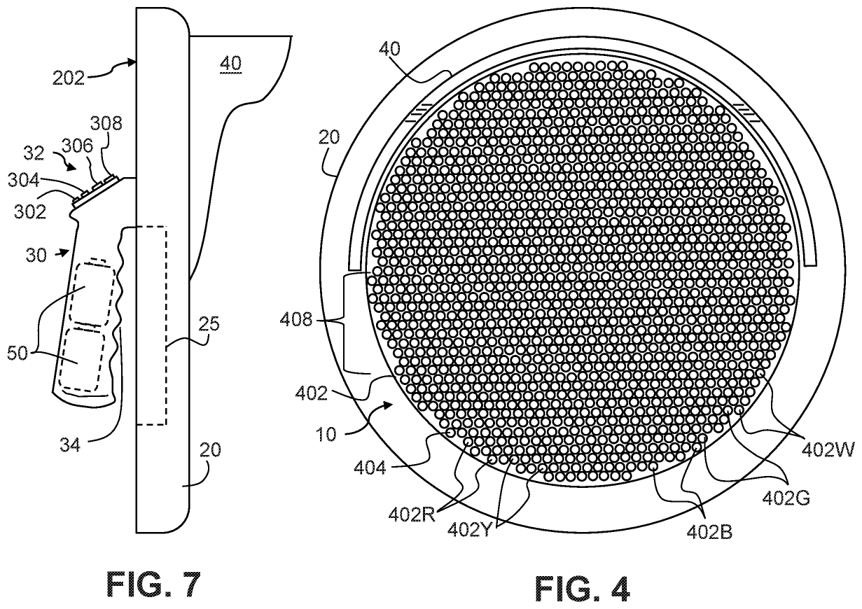

FIG. 4 shows a front view of the portable handheld traffic control device 100. In some embodiments, the lamp 10 of the handheld traffic control device 100 includes a light source 402 having at least one light-emitting diode (LED) 404. Some embodiments include a plurality of the LEDs 404 arranged in an array 408. In some embodiments, the array 408 includes one or more of the LEDs 404 adapted to emit light at a predetermined color, corresponding to a wavelength or range of wavelengths in the visible spectrum. In some embodiments, the lamp 10 includes a light source 402 other than, or in addition to, the LED 404, for example one or more of an incandescent bulb, a halogen bulb, a fluorescent bulb, or an organic light-emitting diode (OLED), without limitation. Light sources 402 according to various embodiments include individual lenses. For example, an LED 404 may have a lens formed integrally around a diode, the lens being made of a resin or thermoplastic, for example.

An embodiment includes a lamp 10 having a plurality of red light sources 402R, a plurality of yellow light sources 402Y, and a plurality of green light sources 402G. Other embodiments include a plurality of the red light sources 402R, a plurality of the green light sources 402G, and a plurality of blue light sources 402B. In some embodiments, the intensity of red light, green light, and blue light may be varied to achieve one or more colors or shades, including white light. Other embodiments include at least one white light source 402W.

In some embodiments, a signal having a red color is achieved by illuminating only the red light sources 402R. In some embodiments, a signal having a yellow color is achieved by illuminating only the yellow light sources 402Y. In some embodiments, a signal having a green color is achieved by illuminating only the green light sources 402G. In some embodiments, a signal having a blue color is achieved by illuminating only the blue light sources 402B. In some embodiments, a signal having a white color is achieved by illuminating only the white light sources 402W. In some embodiments, a signal having any of various colors within a range of colors is achieved by illuminating two or more of the light sources 402R, 402Y, 402G, 402B, and 402W.

Viewed from the front (i.e., the light-emitting side), the handheld device 100 includes the array 408 of the light sources 402 extending in at least two dimensions, for example, in a vertical direction and in a horizontal direction. The light sources 402 are packed in a hexagonal “honeycomb” packing arrangement. In other embodiments, other arrangements are used, for example, rectangular. The number of the light sources 402 is on the order of approximately 1,000. Accordingly, a degree of granularity in the individual points of light emitted is achieved sufficient to define various arrangements, including distinguishable left and right-hand arrows, an upraised hand, and/or a walking person, for example. Other embodiments use more of the light sources 402. Still other embodiments use fewer of the light sources 402.

In an embodiment, the light sources 402 of differing colors are packed together in sufficiently close proximity to achieve dithering, i.e., mixing of colors when viewed from an appropriate distance from the light sources 402. In another embodiment, one or more of the light sources 402 is capable of emitting light at variable wavelengths corresponding to discretely discernible colors, e.g., red, yellow, and green.

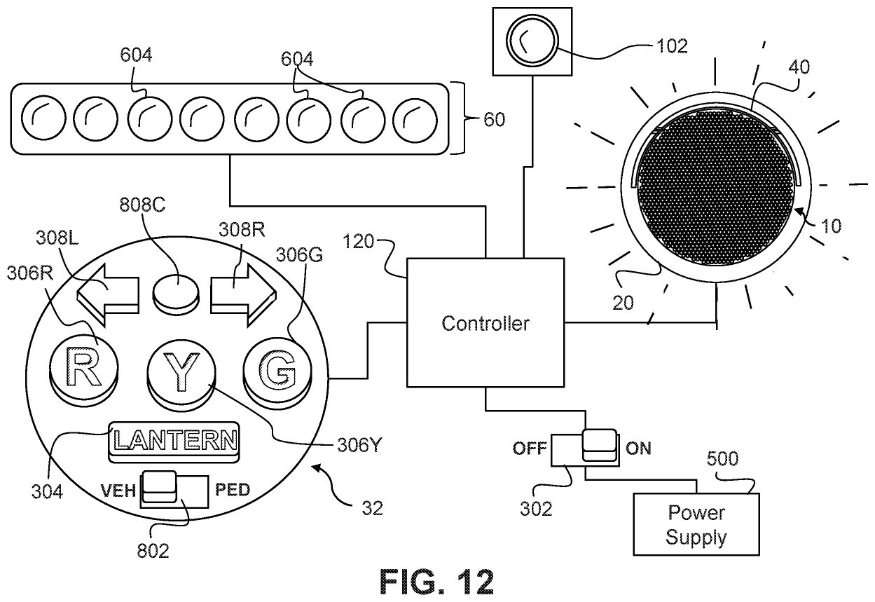

Advantageously, according to some embodiments, it is not necessary to manually place or remove filters to achieve the varying combinations of colors and/or patterns to be displayed by the handheld device 100. In some embodiments, the light sources 402 are controllable via a controller 120 (e.g., an analog control board, a digital microcontroller, a computer, etc.) in response to inputs received from the control panel 32. (See FIG. 12.) In some embodiments, each of the light sources 402 is independently controllable via the controller 120. In other embodiments, the controller 120 addresses a plurality of like light sources via a common signal path or bus. In an embodiment, the lamp 10 comprises a high-density LED board, having on the order of greater than 10 LEDs per inch or even 100 LEDs per inch.

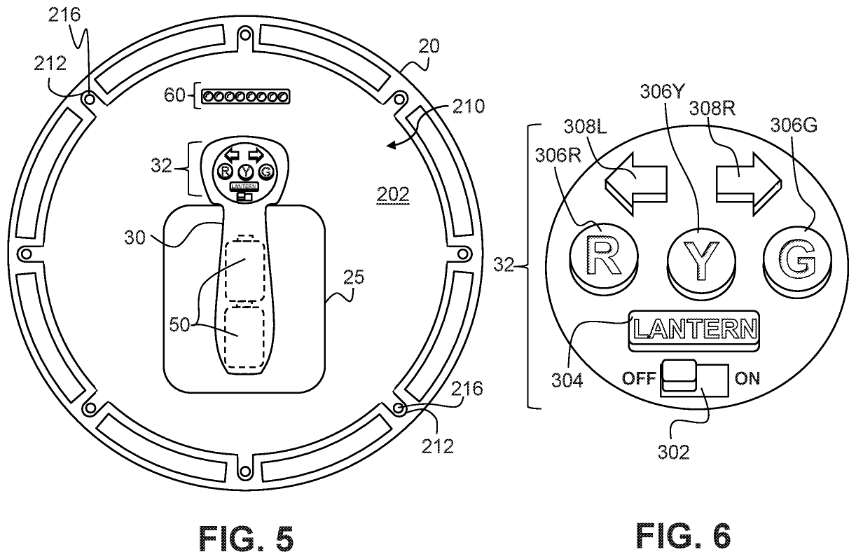

FIG. 5 shows a back view of the device 100 of FIG. 4, according to an embodiment. The portable handheld traffic control device 100 is powered by a power supply 500, which may include one or more batteries 50. In some embodiments, the battery 50 includes at least two battery cells connected in series. In other embodiments the battery 50 includes at least two battery cells connected in parallel. In some embodiments the battery 50 is rechargeable. In other embodiments, the battery 50 is disposable. In some embodiments, the handle 30 encloses the battery 50. In other embodiments, the batteries 50 are distributed in other portions of the device 100. In still other embodiments, the batteries 50 are distributed in the handle 30 and in the housing 20. In still other embodiments, the batteries 50 are distributed toward a bottom (gravity downward) end of the handheld device 100.

In one embodiment, the handheld device 100 operates on 12-Volt direct current (DC) power. In other embodiments, lower or higher voltage electrical power is employed, for example, 1.5-Volt, 3-Volt, 6-Volt, 9-Volt, or 24-Volt DC power. In some embodiments, the handheld device 100 is operable by alternating current (AC) power, such as 120-Volt or 240-Volt power. The handheld device 100 may be powered by plug-in power from an external power source, e.g., an external battery pack, an electrical plug comprised in a motor vehicle, a three-prong wall outlet, or the like.

In some embodiments, the housing 20 and/or the handle 30 of the handheld traffic control device 100 is/are made of a high impact plastic, combination of plastics, and/or combination of plastics and metal. In an embodiment, the back panel 210 includes attachment points 212 to connect the back panel 210 to the proximal side of the housing 20. Each attachment point 212 comprises a fastener 216, such as a machine screw, a clip, or the like, inserted through a corresponding hole into a mating portion (such as a threaded portion) of the lamp housing 20. In some embodiments, the handle 30, the back panel 210, the attachment points 212, and/or the housing 20 includes weatherproofing, such as O-ring seals, overlapping flanges, or the like, to prevent or reduce ingress of moisture, dirt, or other substances that could degrade the electrical and/or electronic components housed in the lamp housing.

The handheld device 100 of the embodiment shown in FIG. 5 includes the handle 30 attached to the rigid housing 20. The housing 20 encloses the lamp 10. The handle 30 is attached to a proximal side 202 of the housing 20. The handle 30 includes a control panel 32.

The handheld device 100 of the embodiment shown in FIG. 5 includes a feedback window 60, by which the device 100 communicates to the user information regarding the active state of the lamp 10. The feedback window 60 is an example of a secondary display visible on the proximal (back) side of the device 100. The feedback window 60 provides a simplified representation of whatever signal the lamp 10 is currently displaying. As the user manipulates the control panel 32, changes in the state of the lamp 10 are shown by corresponding changes in the state of the feedback window 60.

FIG. 6 shows a detailed view of the control panel 32 of shown in FIG. 5 according to one embodiment. The control panel 32 has manual interface elements (302, 304, 306, 308, etc.) to permit a user to: (1) turn the lamp 10 on and off, (2) select a color for the lamp 10 to emit, and (3) select a pattern for the lamp 10 to emit.

The manual interface elements include a power switch 302 to turn the lamp 10 on and off; a lantern button 304 to activate a white lamp color; a red button 306R to activate a red lamp color; a yellow button 306Y to activate a yellow lamp color; a green button 306G to activate a green lamp color; a left-hand arrow button 308L to activate an arrow pointing away from the user on the user's left-hand side when the user's hand grasps the handle 30 with the hand in front of the user; and a right-hand arrow button 308R to activate an arrow pointing away from the user on the user's right-hand side when the user's hand grasps the handle 30 with the hand in front of the user.

The control panel 32 according to an embodiment is integral to a surface angled away from the user's body when held in the user's hand, such that when held in the user's hand, the control panel 32 is proximal to the user's thumb on the hand that grasps the handle 30. The handheld device 100 is operable using a single hand, either right or left, without need of the other hand. Of course, the device 100 also can be operated with both hands. The manual interface elements (302, 304, 306, 308, etc.) can be manipulated by the thumb of the hand that grasps the handle 30.

In various embodiments, the control panel 32 has a substantially circular shape having a diameter of 2 inches; from 0.75 to 1.5 inches; from 1 to 2.25 inches; or from 1.75 to 3 inches, for example. In other embodiments, the control panel 32 has another shape, for example, oblong, rectangle, triangle, octagon, etc. In various embodiment, each of the red, yellow, and green color buttons (306R, 306Y, 306G) has a substantially circular shape having a diameter of 0.33 inches; from 0.2 to 0.3 inches; from 0.25 to 0.4 inches; or from 0.35 to 0.5 inches. In other embodiments, one or more of the red, yellow, and green color buttons (306R, 306Y, 306G) has another shape, for example, oblong, rectangle, triangle, octagon, etc. In various embodiments, each of left and right-hand arrow buttons (308L, 308R) has a shape of an arrow having a dimension in height and/or width of 0.33 inches; from 0.2 to 0.3 inches; from 0.25 to 0.4 inches; or from 0.35 to 0.5 inches. In other embodiments, one or more of the left and right-hand arrow buttons (308L, 308R) has another shape, for example, oblong, rectangle, triangle, octagon, etc. The red, yellow, and green color buttons (306R, 306Y, 306G) and the lantern button 304 are examples of color selectors. The left and right-hand arrow buttons (308L, 308R) are examples of pattern selectors. Other embodiments of a color selector include one or more additional manual interface elements. Other embodiments of a pattern selector include one or more additional manual interface elements.

FIG. 7 shows a side view of the device 100 according to an embodiment. The handle 30 attaches to the proximal side 202 of a back panel 210 of the lamp housing 20. In some embodiments, the handle 30 is formed integrally with the back panel 210. In some embodiments, the handle 30 is separable.

Viewed from the side (see, e.g., FIGS. 1, 2, and 7), the lamp housing 20 includes an indentation 25 to accommodate the fingers and/or knuckles of a user's hand as it grips the handle 30. This can also have the benefit of improving forward-backward balance of the handheld device 100, such that the device 100 tends to remain balanced in the user's hand, rather than tipping forward or backward. The indentation 25 is also shown in FIG. 5.

In some embodiments, the center of gravity of the device 100 is below a top edge of the user's hand when grasping the handle 30. With the weight of the batteries 50 or other heavy components in, near, or below the handle 30 itself, the center of gravity of the device 100 may be optimized such that mechanical moments (corresponding to torques) and resulting discomfort in a user's hand are minimal. In an embodiment, the handle 30 includes an ergonomic grip portion 34 to facilitate comfort even during extended use. For example, a police officer holding the handle 30 for an extended period, as may be necessary during a power outage that disables a fixed roadside traffic signal, may benefit from improved ergonomics.

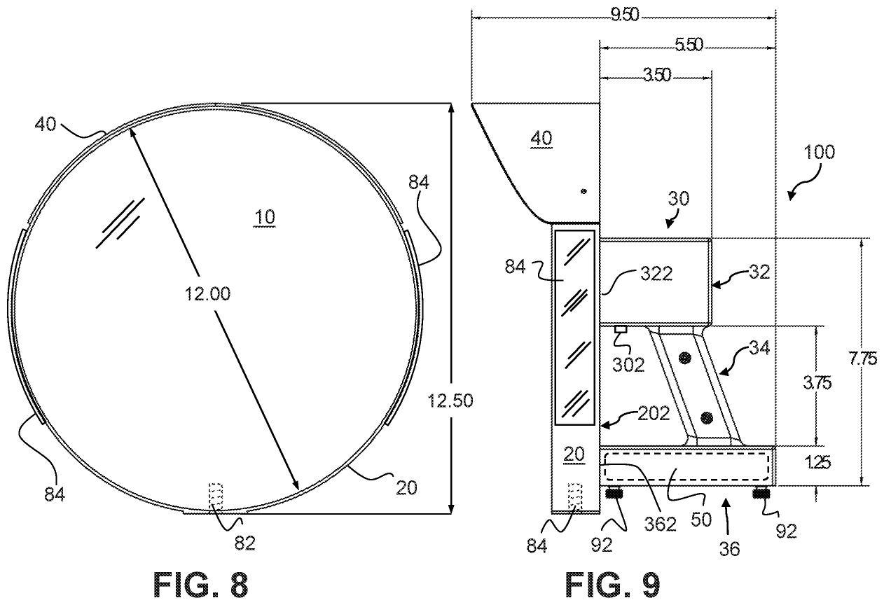

FIG. 8 shows a front view of another embodiment of the device 100. The lamp 10 has a diameter of 12 inches. The lamp housing has a height of 12.5 inches. The lamp housing 20 includes a tripod mount 27, shown in dashed lines. The tripod mount 27 extends vertically into the lamp housing 20 to permit attachment of the device 100 to a tripod, or another fixed mounting point, in substantially like manner as a photographic camera may be mounted on a tripod.

In some embodiments, the device 100 includes a reflective portion 84 on one or more outward-facing edge portions of the lamp housing 20. The reflective portions 84 on left and right sides of the device 100 may provide an additional safety mechanism by providing enhanced visibility for a user operating the device 100. For example, when a vehicle such as an automobile approaches the user in the dark from a side perpendicular to a direction in which the lamp 10 is facing, an operator of the automobile may be substantially unable to see the lamp 10, much less the user. However, light emitted from the automobile's headlights may be reflected off the reflective portions 84, thereby alerting the automobile operator to the presence of the device 100 and user ahead. In some embodiments, the reflective portion 84 includes a reflective film. In some embodiments, the reflective portion 84 includes metallic, glass, and/or plastic elements to reflect incident light.

FIG. 9 shows a side view of the device 100 shown in FIG. 8. The device 100 includes the handle 30, the control panel 32, and a battery compartment 36. The battery compartment 36 has a shape and size adapted to receive a replaceable battery 50. Thumb screws 92 thread into holes in the battery compartment 36 to permit the battery compartment 36 to be opened manually to swap the battery 50 for a replacement battery 50.

The handle 30 further includes a primary attachment portion 322 and a secondary attachment portion 362. The primary attachment portion 322 extends from an upper end of the handle 30 to the proximal side 202 of the lamp housing 20. The secondary attachment portion 362 extends from a lower end of the handle 30 to the proximal side 202 of the lamp housing 20. In one embodiment, the primary attachment portion 322 and/or the secondary attachment portion 362 are formed integrally in one piece with the proximal side 202. In other embodiments, fasteners or other engagement means are provided to fix the primary attachment portion 322 and/or the secondary attachment portion 362 to the proximal side 202.

In various embodiments, the handle 30, from the bottom of the battery compartment 36 to top of the primary attachment portion 322 measures 7.75 inches; from 6 to 9 inches; or from 8 to 13 inches.

In various embodiments, the primary attachment portion 322, from the proximal side 202 to the control panel 32, measures 3.5 inches; from 2 to 5 inches; or from 4 to 6 inches.

In various embodiments, the grip portion 34 has a height measuring 3.75 inches; from 2.75 to 4.5 inches; or from 4 to 8 inches.

In various embodiments, the batter compartment 36 has a length extending away from the proximal side 202 measuring 5.5 inches; from 4 to 6.5 inches; or from 6 to 9 inches.

In various embodiments, the device 100 has an overall length extending from a front edge of the sun shield 40 to a rear edge of the handle 30 measuring 9.5 inches; from 5 to 11 inches; or from 10 to 14 inches.

In various embodiments, the portable handheld traffic control device 100 has an overall size of from 3 to 5 inches width by 3 to 5 inches height, by 3 to 5 inches depth. In other embodiments, the portable handheld traffic control device 100 has an overall size of from 4 to 10 inches in each of width, height, and depth. In other embodiments, the portable handheld traffic control device 100 has an overall size of from 9 to 24 inches in each of width, height, and depth. In some embodiments, the portable handheld traffic control device 100 has an overall front-to-back depth of 3 to 8 inches, an overall height from top to bottom of 12 to 30 inches, and an overall width of from 8 to 24 inches. According to various embodiments, the portable handheld traffic control device 100 may be substantially taller than it is wide, or vice-versa.

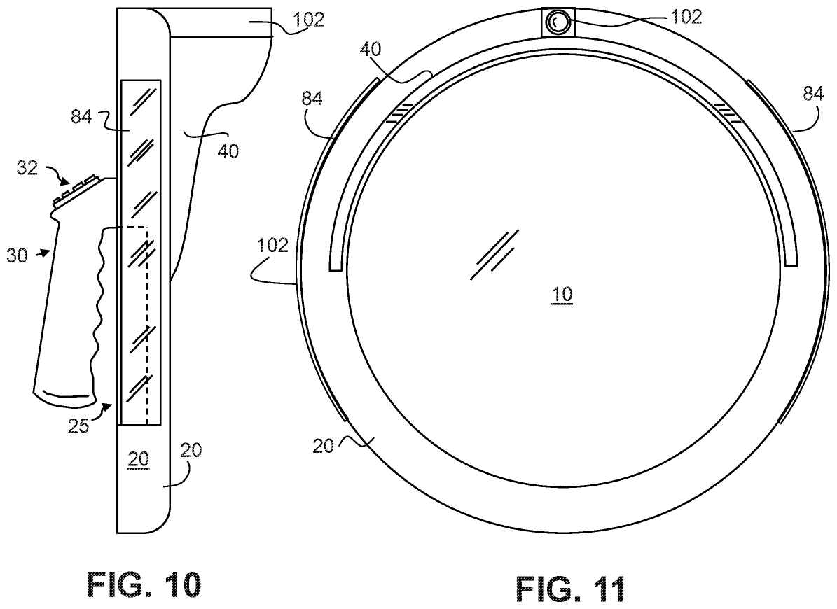

FIG. 10 shows a side view of an exemplary embodiment of the device 100. The device 100 includes a camera 102. The camera 102 is oriented along an axis substantially parallel to the emission direction of the lamp 10. In other embodiments, the camera 102 swivels in a camera mount that permits the camera 102 to be oriented along another axis that diverges from the emission direction of the lamp 10.

FIG. 11 shows a front view of the device 100 shown in FIG. 10. The camera 102 is mounted on top of the sun shield 40. However, in other embodiments, the camera 102 is mounted below the sun shield 40. In still other embodiments, the camera 102 is arranged integral to the sun shield 40. According to various embodiments, the camera 102 may be a digital camera including a sensor, for example a CCD or CMOS sensor. Some embodiments include a thermal imaging sensor or a night-vision sensor. The camera 102 may include a lens, such as a zoom lens, having focal elements to permit a clear image to be formed on a plane of the sensor. In one embodiment, the camera 102 is an HD video camera having a resolution of 1280 by 720 or 1920 by 1080. The camera 102 may be a 4K camera. The camera 102 may have a refresh rate of 30 frames-per-second (fps); from 24 to 120 frames fps; or from 60 to 240 fps. Other embodiments utilize a still camera.

FIG. 12 shows a schematic view of the device 100 according to an embodiment. The power supply 500 provides electrical power via the power switch 302 to the controller 120, the lamp 10, the control panel 32, the feedback window 60, and the camera 102. The power switch 302 is switchable between an OFF position, where current is not permitted to flow, and an ON position where the electrical current is permitted to flow. In some embodiments, the power switch 302 is situated on the control panel 32. (See FIG. 6). In other embodiments, the power switch 302 is situated on a different portion of the device 100. For example, the power switch 302 may be situated on a bottom surface of the primary attachment portion 322. (See FIG. 9). In another embodiment, the power switch 302 is situated on a top surface of the primary attachment portion 322.

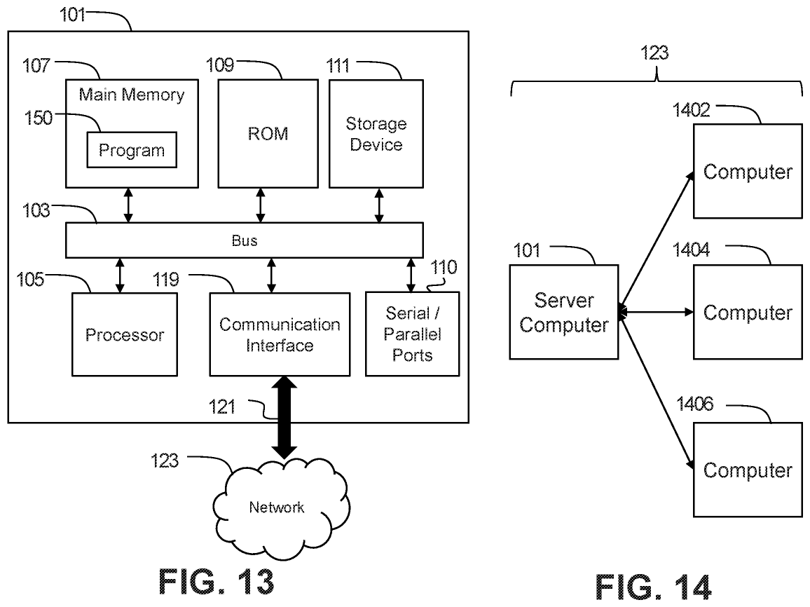

The camera 102 connects to the controller 120 such that images and/or video acquired by the camera 102 may be processed, stored, and/or communicated over a network to a remote device. (See FIGS. 13 and 14.) In some embodiments, the controller 120 includes a digital signal processor (DSP), a codec, and/or a graphics chip, to capture, encode, and/or compress images and/or video acquired by the camera 102.

In some embodiments, the controller 120 is configured to begin capturing video when the device 100 is powered on, and to cease capturing video when the device 100 is powered off. In other embodiments, the device 100 includes a button or selector operable to start and/or stop capturing video from the camera 102. In other embodiments, the camera is controlled exclusively from a remote device, such as a computer or a mobile device. (See FIGS. 13 and 14.)

The control panel 32 includes the lantern button 304, the red button 306R, the yellow button 306Y, the green button 306G, the left-hand arrow button 308L, and the right-hand arrow button 308R. The control panel 32 also includes a circle pattern button 808C and a signal mode selector 802. The circle pattern button 808C is operable to cause the lamp to display a pattern having a circular shape. For example, when either the left-hand arrow button 308L or the right-hand arrow button 308R is active, pressing the circle pattern button 808C causes the lamp to switch from showing an arrow to showing a circle.

The signal mode selector 802 is switchable between a VEH (vehicle) position and a PED (pedestrian) position. With the signal mode selector 802 in the VEHICLE position, the device 100 is configured to display signals appropriate for motor vehicles. With the signal mode selector 802 in the PEDESTRIAN position, the device 100 is configured to display signals appropriate for pedestrians. When a user manipulates any of the manual interface elements (302, 304, 306R, 306Y, 306G, 308L, 308R, 808C, 802), the controller 120 sets the lamp 10 to display a predetermined signal. Likewise, when a user manipulates any of the manual interface elements (302, 304, 306R, 306Y, 306G, 308L, 308R, 808C, 802), the controller 120 sets the feedback window 60 to display a response corresponding to the signal displayed by the lamp 10.

In some embodiments, the feedback window 60 includes a plurality of light-emitting diodes (LEDs) 604. For example, 8 LEDs arrayed in a single line between left and right-hand sides of the housing 20 are used in the embodiment shown in FIG. 12. Each of the LEDs 604 is an RGB LED, adaptable to emit light at varying wavelengths including, but not limited to, red, green, blue, yellow, and white. In other embodiments, other light sources are used in the feedback window 60. According to some embodiments, the feedback window 60 provides light whereby the manual interface elements (302, 304, 306R, 306Y, 306G, 308L, 308R, 808C, 802) are made visible to a user operating the device 100 in a dark environment. In other embodiments, the control panel 32 and/or one or more of the manual interface elements (302, 304, 306R, 306Y, 306G, 308L, 308R, 808C, 802) includes a backlight whereby such may be made visible to a user operating the device 100 in a dark environment.

FIG. 13 shows an exemplary computer 101 consistent with systems and methods of the present disclosure. In some embodiments, the computer 101 serves as the controller 120 to translate a user's button presses, or other manipulations of the control panel 32, into changes in the signal displayed by the lamp 10. The computer 101 includes a bus 103 or other communication mechanism for communicating information and a processor 105 coupled with bus 103 for processing the information. The computer 101 also includes a main memory 107, such as a random access memory (RAM) or other dynamic storage device, coupled to the bus 103 for storing information and instructions to be executed by processor 105. In addition, the main memory 107 may be used for storing temporary variables or other intermediate information during execution of instructions to be executed by the processor 105. The main memory 107 includes a program 150 for implementing methods and systems consistent with the present disclosure. The computer 101 further includes a read-only memory (ROM) 109 or other static storage device coupled to the bus 103 for storing static information and instructions for the processor 105. Serial and/or parallel ports 110 are provided to the bus 103 for allowing various external devices to communicate with the computer 101. For example, where the controller 120 may use a serial and/or parallel port 110 to communicate with the camera 102. A storage device 111, such as a magnetic disk or optical disk, is provided and coupled to the bus 103 for storing information and instructions. The computer 101 may be a server, a personal computer, a mobile device such as a smartphone, a tablet, the device 100, or another computing device in various non-limiting embodiments.

According to one embodiment, the processor 105 executes one or more sequences of one or more instructions contained in the main memory 107. Such instructions may be read into the main memory 107 from another computer-readable medium, such as the storage device 111. Execution of the sequences of instructions in the main memory 107 causes the processor 105 to perform the process steps described herein. One or more processors in a multi-processing arrangement may also be employed to execute the sequences of instructions contained in the main memory 107. In alternative embodiments, hard-wired circuitry may be used in place of or in combination with software instructions. Thus, embodiments are not limited to any specific combination of hardware circuitry and software.

Although described relative to the main memory 107 and the storage device 111, instructions and other aspects of methods and systems consistent with the present disclosure may reside on another computer-readable medium, such as a floppy disk, a flexible disk, hard disk, flash drive, magnetic tape, a CD-ROM, magnetic, optical or physical medium, a RAM, a PROM, an EPROM, a FLASH-EPROM, any other memory chip or cartridge, or any other medium from which a computer can read, either now known or later discovered. In some embodiments, various parameters of the light source 402 (e.g., timing, intensity (brightness), color) are varied according to methods stored in a computer-readable medium.

The computer 101 also includes a communication interface 119 coupled to the bus 103. The communication interface 119 provides a two-way data communication coupling to a network link 121 that is connected to a network 123, such as the Internet or other computer network. Wireless links may also be implemented. In any such implementation, communication interface 119 sends and receives signals that carry digital data streams representing various types of information.

In one implementation, the computer 101 may operate as a web server on the computer network 123, for example, the Internet. The computer 101 may also represent other computers on the Internet, such as one or more users' computers, mobile devices, and/or smartphones having web browsers and the user's computers may have similar components as the computer 101.

FIG. 14 shows the exemplary computer network 123 such as the Internet having a web server computer 101 for a website and computers (1402, 1404, 1406, etc.) used by various potential network participants. As described above, the computer 101 may be a server having the components described above and may implement methods and systems consistent with the present disclosure. The computers 1402, 1404, and 1406 may include web browsers and may be used by users to access the Internet or other network 123 and access the server computer 101. There may be any number of the user computers (1402, 1404, 1406, etc.) and any number of the server computers 101. Users of the computers 1402 through 1406, for example, may be users on the disclosed systems, including the device 100, by accessing the server computer 101. These computers 101 may be operated by these users.

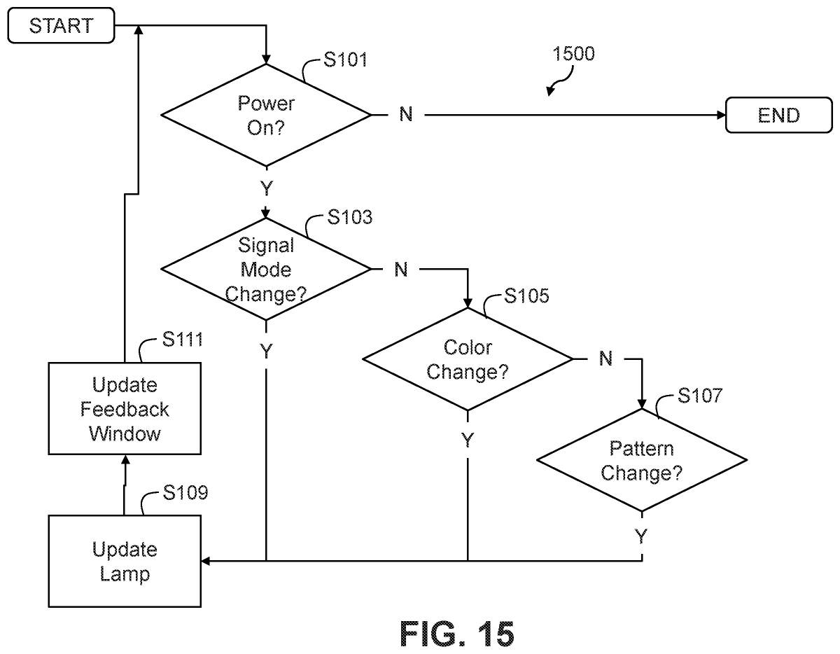

FIG. 15 shows a method according to an embodiment. The method is a control method 1500 for controlling the device 100 based on inputs received from a user. The control method 1500 starts by checking to see whether power is being supplied (step S101), i.e., in the form of an electrical current available at a predetermined voltage from the power supply 500. If the power is OFF, the control method 1500 ends. If the power is ON, the control method 1500 proceeds to step S103. So long as power is supplied, the control method 1500 operates as a continuous loop, returning to step S101 after completing the proceeding steps.

The control method 1500 checks to see whether a signal mode has changed (S103). If the signal mode has changed, i.e., since the last time the method 1500 encountered step S103, then the lamp 10 is updated (S109) and the feedback window 60 is updated (S111) in a manner corresponding to the change in signal mode. A change in signal mode may arise whenever a user switches the signal mode selector 802 from VEHICLE to PEDESTRIAN or vice versa. If the signal mode has not changed, then the method 1500 proceeds to step S105.

The control method 1500 checks to see whether a color has changed (S105). If the color has changed, i.e., since the last time the method 1500 encountered step S105, then the lamp 10 is updated (S109) and the feedback window 60 is updated (S111) in a manner corresponding to the change in color. A change in color may arise whenever a user presses one of the color buttons, e.g., lantern button 304, red button 306R, yellow button 306Y, or green button 306G. If the color has not changed, then the method 1500 proceeds to step S107.

The control method 1500 checks to see whether a pattern has changed (S107). If the pattern has changed, i.e., since the last time the method 1500 encountered step S107, then the lamp 10 is updated (S109) and the feedback window 60 is updated (S111) in a manner corresponding to the change in pattern. A change in patter may arise whenever a user presses one of the arrow buttons, e.g., left-hand arrow button 308L, or right-hand arrow button 308R. If the pattern has not changed, then the method 1500 proceeds to step S109. In other embodiments, the sequence of the steps S103 through S107 is rearranged and/or reversed.

At step S109, the control method 1500 instructs the lamp 10 to emit light in accordance with a predetermined signal for any combination of signal mode (VEHICLE or PEDESTRIAN), color (LANTERN, RED, YELLOW, or GREEN), and pattern (LEFT ARROW or RIGHT ARROW).

At step S111, the control method 1500 instructs the feedback window 60 to display a predetermined response for any of the predetermined signals emitted by the lamp 10. In other embodiments, the sequence of the steps S109 and S111 is reversed.

Having completed steps S103 through S111, the method 1500 returns to S101 and repeats.

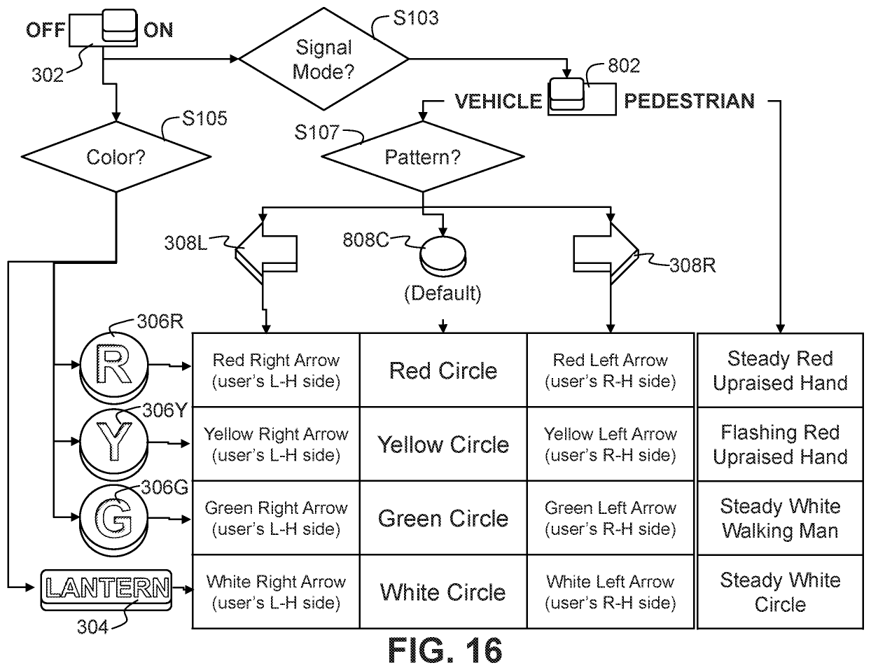

FIG. 16 shows a flowchart and resulting states for a method according to an embodiment. FIG. 16 shows portions of the method 1500 of FIG. 15, further showing the predefined visual signals displayed by the lamp 10 resulting from various combinations of signal mode (S103), color (S105), and pattern (S107).

As shown in FIG. 16, the signal mode and the color can be varied independently. That is, for a given color, the lamp 10 has a corresponding signal, no matter whether the device 100 is in the vehicle mode (VEH at the step S103) or the pedestrian mode (PED at the step S103). More particularly, as shown in FIG. 16, when the device 100 is in the vehicle mode (VEH at the step S103), there is a default shape for the pattern (e.g., circle), such that pressing the lantern button 304 causes the lamp 10 to display a white circle, pressing the red button 306R causes the lamp 10 to display a red circle; pressing the yellow button 306Y causes the lamp 10 to display a yellow circle; and pressing the green button 306G causes the lamp 10 to display a green circle. In various embodiments, the default pattern can be any pattern or shape formable by the lamp 10. Likewise, in some embodiments, the device 100 has a default color, such that after the device 100 is turned on (S101), even before a particular color button is pressed, the lamp 10 will default to using its default color. The default color may be any color the lamp 10 can emit. In one embodiment, the default color is white. In another embodiment, the default color is red.

As shown in FIG. 16, when the device 100 is in the vehicle mode (VEH at the step S103), pressing the left-hand arrow button 308L causes the lamp 10 to display a RIGHT ARROW (pointing on the left-hand side, as viewed from the user's perspective), for any of the colors (RED, YELLOW, GREEN, or WHITE). When the device is in the vehicle mode (VEH at the step S103), pressing the right-hand arrow button 308R causes the lamp 10 to display a LEFT ARROW (pointing on the right-hand side, as viewed from the user's perspective), for any of the colors (RED, YELLOW, GREEN, or WHITE).

But as further shown in FIG. 16, when the device 100 is in the pedestrian mode (PED at the step S103), pressing the left-hand arrow button 308L and/or the right-hand arrow button 308R has no effect. This is because, according to the embodiment shown and described here, it is not sought to display left and right directional cues while in the pedestrian mode. Instead, when the device 100 is in the pedestrian mode (PED at the step S103), pressing the lantern button 304 causes the lamp to display a steady white circle, which may be useful as a general purpose torch or flashlight; pressing the red button 306R causes the lamp 10 to display a steady red upraised hand, signaling to pedestrians that it is unsafe to walk; pressing the yellow button 306Y causes the lamp 10 to display a flashing red upraised hand, signaling to pedestrians that if they are walking, they must proceed with caution; and pressing the green button 306G causes the lamp 10 to display a steady white walking person, signaling to pedestrians that it is safe to walk.

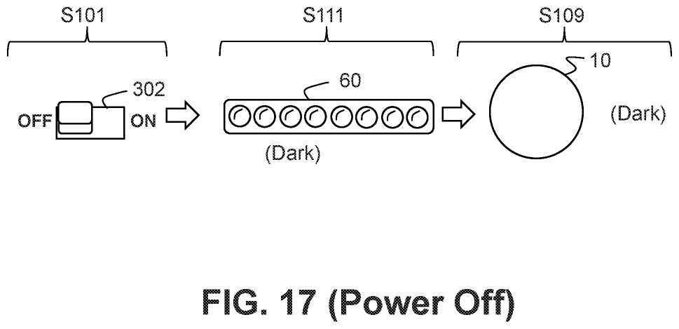

FIGS. 17 through 20B show correspondences between the manual interface elements, the feedback window 60, and the lamp 10 for the steps of the method 1500.

In FIG. 17, initially (step S101) if the power is OFF, then the feedback window 60 is dark and the lamp 10 is dark.

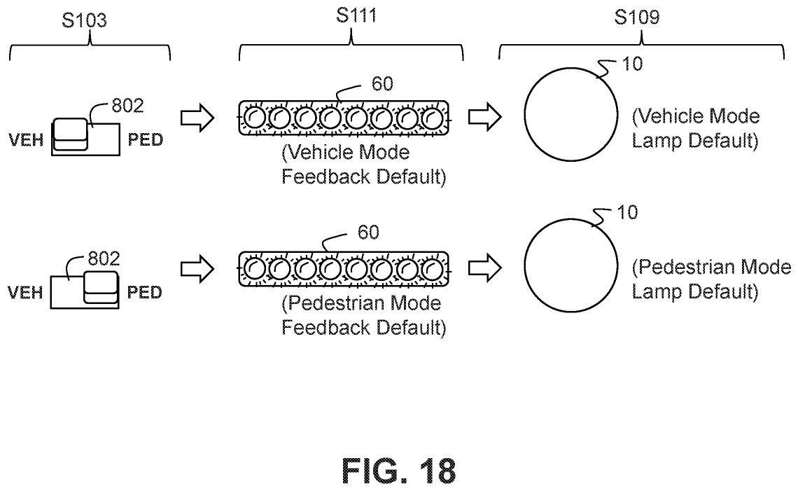

In FIG. 18, if the power is ON, and if (step S103) the signal mode is set to VEHICLE, where none of the color buttons (304, 306R, 306Y, 306G) has been pressed, then (step S111) the feedback window 60 shows a predetermined default indication for the vehicle mode and (step S109) the lamp 10 likewise displays a predetermined default signal for the vehicle mode. In one embodiment, for the vehicle mode, the window 60 has a default indication of solid green and the lamp 10 has a default signal of solid green. In other embodiments, the settings in effect immediately before the last power-off event (step S101) are stored as the defaults and retrieved the next time the device 100 is powered on. In still other embodiments, other defaults are used.

In FIG. 18, if the power is ON, and if (step S103) the signal mode is set to PEDESTRIAN, where none of the color buttons (304, 306R, 306Y, 306G) has been pressed, then (step S111) the feedback window 60 shows a predetermined default indication for the pedestrian mode and (step S109) the lamp 10 likewise displays a predetermined default signal for the pedestrian mode. In one embodiment, for the pedestrian mode, the window 60 has a default indication of solid white and the lamp 10 has a default signal of steady white. In other embodiments, the settings in effect immediately before the last power-off event (step S101) are stored as the defaults and retrieved the next time the device 100 is powered on. In still other embodiments, other defaults are used.

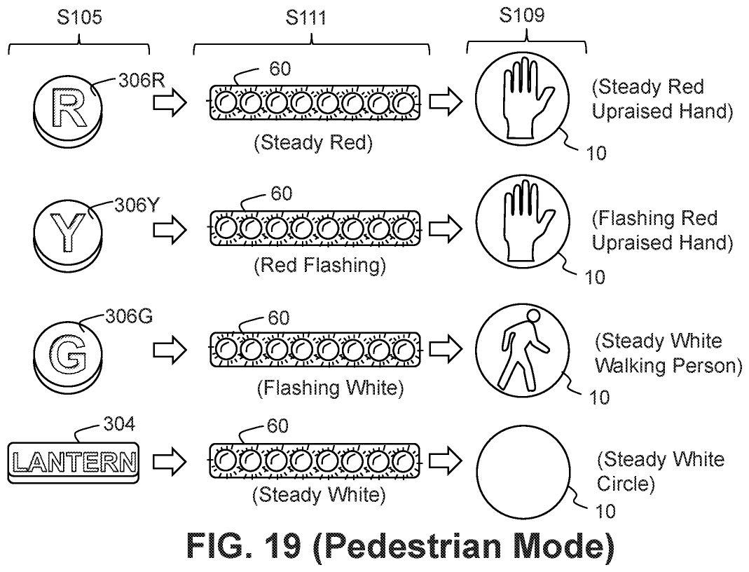

In FIG. 19, if (step S103) the signal mode is set to PEDESTRIAN and (step S105) the lantern button 304 is pressed, then (step S111) the feedback window 60 shows steady white and (step S109) the lamp 10 shows a steady white circle. In the pedestrian mode, if (step S105) the red button 306R is pressed, then (step S111) the feedback window 60 shows steady red and (step S109) the lamp 10 shows a steady red upraised hand. In the pedestrian mode, if (step S105) the yellow button 306Y is pressed, then (step S111) the feedback window 60 shows steady yellow and (step S109) the lamp 10 shows a flashing red upraised hand. In the pedestrian mode, if (step S105) the green button 306G is pressed, then (step S111) the feedback window 60 shows flashing white and (step S109) the lamp 10 shows a steady white walking person.

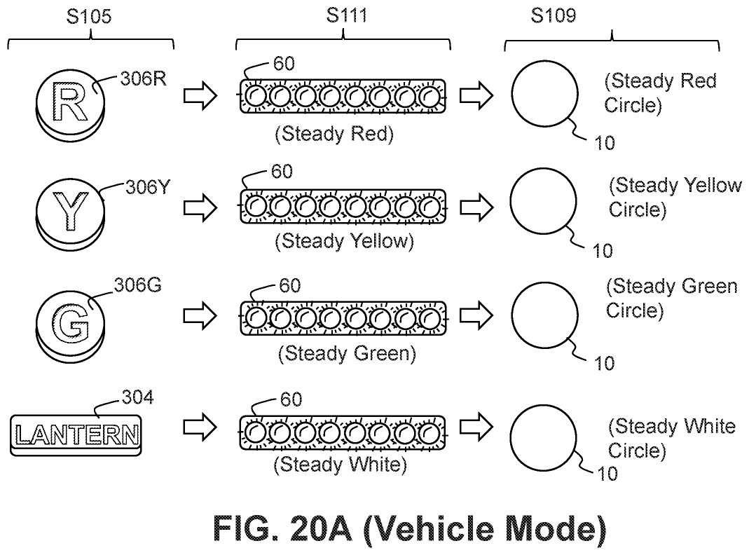

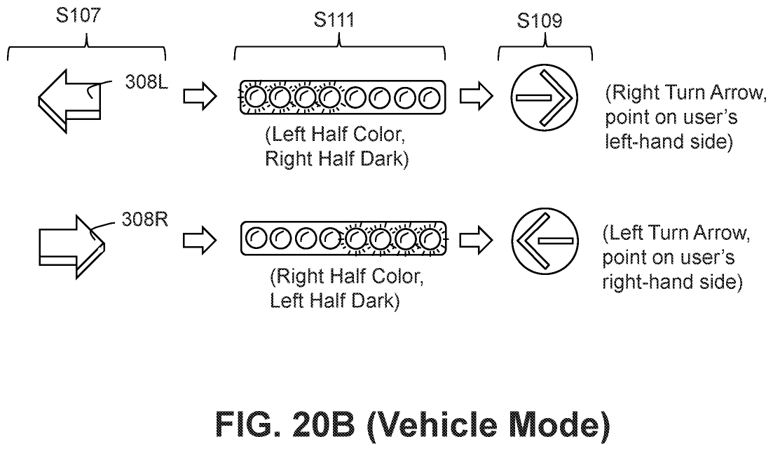

In FIG. 20A, if (step S103) the signal mode is set to VEHICLE and (step S105) the lantern button 304 is pressed, then (step S111) the feedback window 60 shows steady white and (step S109) the lamp 10 shows a steady white circle. In the vehicle mode, if (step S105) the red button 306R is pressed, then (step S111) the feedback window 60 shows steady red and (step S109) the lamp 10 shows a steady red circle. In the vehicle mode, if (step S105) the yellow button 306Y is pressed, then (step S111) the feedback window 60 shows steady yellow and (step S109) the lamp 10 shows a steady yellow circle. In the vehicle mode, if (step S105) the green button 306G is pressed, then (step S111) the feedback window 60 shows steady green and (step S109) the lamp 10 shows a steady green circle.

In FIG. 20B, if (step S103) the signal mode is set to VEHICLE and (step S105) the left-hand arrow button 308L is pressed, then (step S111) the feedback window 60 shows its left half (four LEDs) in the currently active color setting and its right half (the four remaining LEDs) is dark and (step S109) the lamp 10 shows a right turn arrow, with its point on the user's left-hand side). That is oncoming traffic will perceive the lamp 10 as showing a colored arrow pointing in the same direction as if the user (facing oncoming traffic) extended his or her left arm away from the body to direct the traffic to turn. In the vehicle mode, if (S107) the right-hand arrow button 308R is pressed, then (step S111) the feedback window 60 shows its right half (the four LEDs) in the currently active color setting and its left half (the four remaining LEDs) is dark and (step S109) the lamp 10 shows a left turn arrow, with its point the user's right-hand side). That is, oncoming traffic will perceive the lamp 10 as showing a colored arrow pointing in the same direction as if the user (facing oncoming traffic) extended his or her right arm away from the body to direct the traffic to turn.

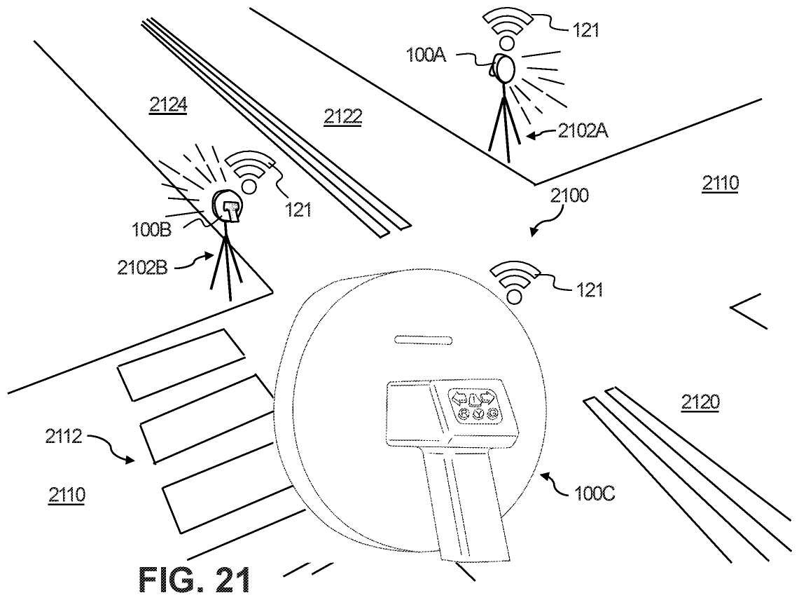

FIG. 21 shows a system including three (3) of the device 100 deployed at an intersection 2100. The intersection 2100 includes a road 2110 having a crosswalk 2112 and a second road 2120 having opposing travel lanes 2122 and 2124. At one corner of the road 2110 and the lane 2122 stands a first tripod 2102A on which is mounted a first device 100A. The first device 100A faces vehicular traffic approaching the intersection along the first lane 2122.

At a corner of the road 2110 and the lane 2124 stands a second tripod 2102B on which is mounted a second device 100B. The second device 100B faces vehicular traffic approaching the intersection along the second lane 2124 from a direction opposite the direction of the first lane 2122.

At a corner of the road 2110 and the lane 2124 opposite the second device 100B stands a user holding a third device 100C. The third device 100C faces pedestrian traffic approaching the crosswalk 2112 from the side of the road 2110 where the second device 100B is situated.

Each of the three devices (100A, 100B, 100C) includes a network link 121. In some embodiments, the network links 121 form an ad-hoc mesh network between the devices 100A, 100B, and 100C themselves. In other embodiments, the network links 121 connect the devices 100A, 100B, and 100C to a larger network 123, such as the Internet.

In some embodiments, the first and second devices (100A, 100B) are operated remotely by a user grasping the device 100C in his or her hand. For example, according to various embodiments, each of the devices 100A, 100B, 100C is configurable to receive and respond to commands transmitted from one or more of the other devices. Thus, in an embodiment, when the user manually operating the third device 100C changes a state of the third device 100C, the first and second devices 100A and 100B receive information regarding the change of the state of the third device 100C and are automatically updated in a manner appropriate for the arrangement of the first and second devices (100A, 100B) at the intersection 2100.

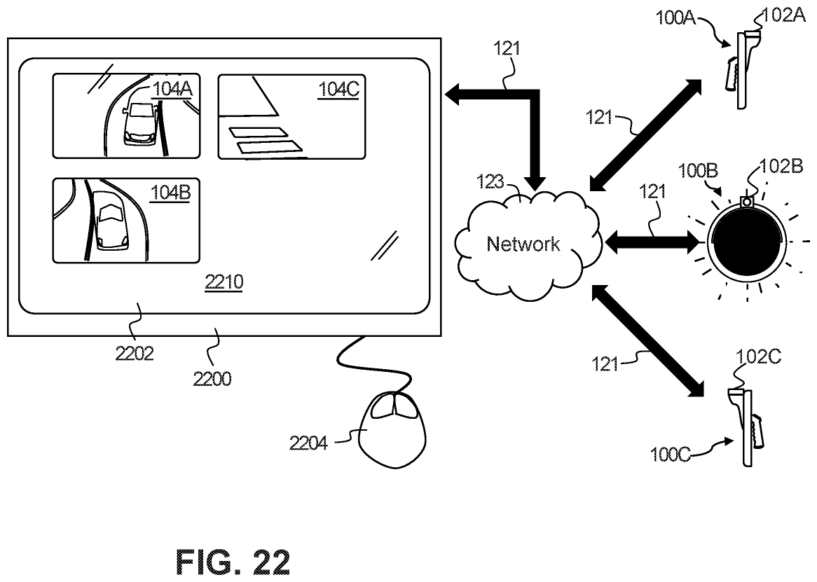

FIG. 22 shows a system including the system and devices of FIG. 21 and further including a headquarters device 2200. In some embodiments, the headquarters device is a computer, such as the computer 101. The headquarters device 2200 includes a network link 121, by which the headquarters device 2200 connects to one or more of the devices (100A, 100B, 100C), or any other number of the devices 100. In some embodiments, the headquarters device 2200 and the devices 100 connect via the network 123.

The headquarters device 2200 receives a live video stream 104 from the camera 102 in each of the connected devices 100. The headquarters device 2200 includes a display 2202. Video streams 104A, 104B, 104C corresponding to each of the connected devices 100A, 100B, 100C, are displayed in a graphical user interface (GUI) 2210 shown on the display 2202. In an embodiment, the GUI 2210 includes a grid or array of video streams 104. In other embodiments, the GUI 2210 includes other elements and arrangements. The headquarters device 2200 includes a human-interface device (HID) 2204 such as a mouse. A user of the headquarters device 2200 uses the HID 2204 to interact with the GUI 2210. In other embodiments, other human-machine paradigms are used.

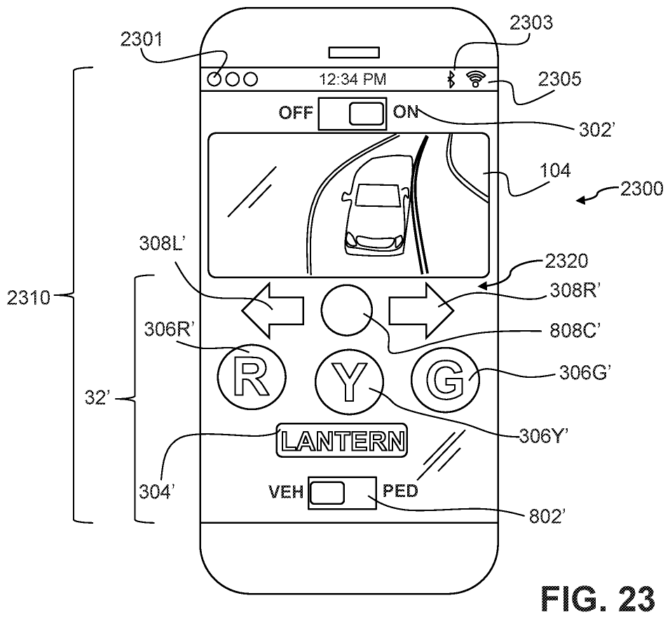

FIG. 23 shows a mobile device 2300. In some embodiments, the mobile device 2300 is a smartphone, a tablet, or the like. The mobile device 2300 includes a mobile user interface (UI) 2310 accessible by a touchscreen 2320. The mobile UI 2310 includes status indicators reflecting various means of network connectivity, including cellular (2301), Bluetooth (2303), and Wi-Fi (2305). Each of these network connectivity means is a network link 121 connectable to one or more of the devices 100 and/or to the headquarters device 2200, either directly, or by the network 123. The mobile UI 2310 displays a video stream 104 from a connected device 100.

The mobile UI 2310 includes interactive touchscreen elements arranged in a software control panel 32′ mimicking a physical size and layout of the control panel 32. For example, the software control panel 32′ may include touchscreen interface elements 302′, 304′, 306R′, 306Y′, 306G′, 308L′, 308R′, 808′, 802′ corresponding to each of the manual interface elements 302, 304, 306R, 306Y, 306G, 308L, 308R, 808, 802, respectively.

A user may control the connected device 100 by the software control panel 32′ to remotely control the device 100 in a manner similar to the way the user would manually operate the device 100 using the control panel 32. For example, the software control panel 32′ may permit operation of the device 100 using only the thumb of one or the other of the user's hands, the other fingers of the user's hand grasping the mobile device 2300. Moreover, the software control panel 32′ can be used to operate the device 100 remotely. For example, the software control panel 32′ can be used to operate the device from the safety and comfort of a user's vehicle, or from inside a building.

In some embodiments, the GUI 2210 and/or the mobile UI 2310 further include controls whereby the timing and other parameters of the operation of one or more of the remote devices 100 may be scheduled and/or automated.

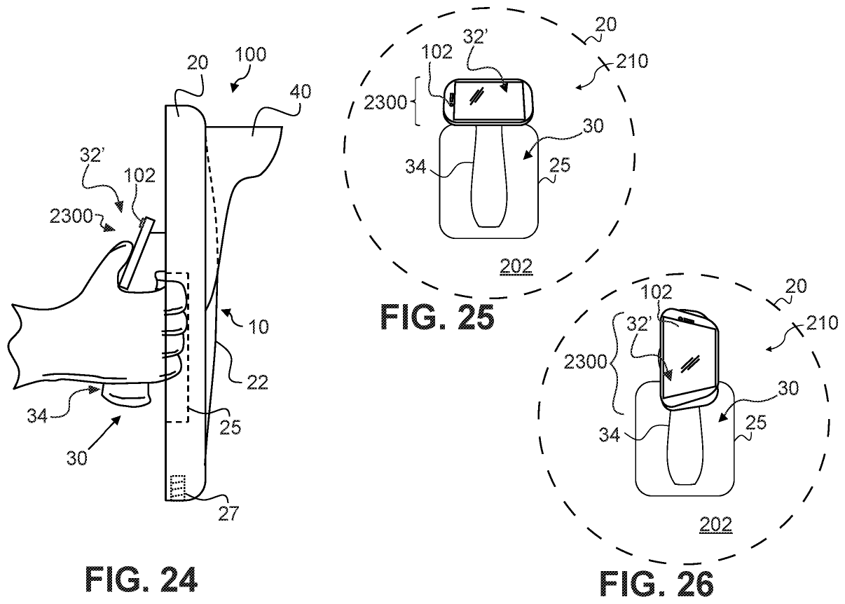

FIG. 24 shows a side view of a portable handheld traffic control device 100 in use according to another embodiment. In the portable handheld traffic control device 100 as shown in FIG. 24, a software control panel 32′ is proximal to a user's thumb on a hand that grasps a grip portion 34 of the handle 30. In some embodiments, the grip portion 34 has a substantially cylindrical shape. In other embodiments, the grip portion 34 has a substantially prismatic shape. In still other embodiments, the grip portion 34 has an ergonomic shape including compound curvature suited to mesh with the fingers, interdigital spaces, and palm of a hand grasping the grip portion 34 in use. A mobile device 2300 is positioned adjacent to the handle 30. A software control panel 32′ is provided on the mobile device 2300. A mobile UI 2310, such as, for example, the mobile UI 2310 shown in FIG. 23, is proximal to the user's thumb on the hand that grasps the handle 30. The portable handheld traffic control device 100 is operable using a single hand, either right or left, without need of the other hand. Of course, the portable handheld traffic control device 100 also can be operated with both hands. Touchscreen interface elements 302′, 304′, 306R′, 306Y′, 306G′, 308L′, 308R′, 808′, 802′ correspond to each of the manual interface elements discussed with respect to other embodiments 302, 304, 306R, 306Y, 306G, 308L, 308R, 808, 802, respectively. In some embodiments, the mobile device 2300 includes a camera 102 on a front face, i.e., facing the user when in use. Accordingly, still photos, and/or video may be captured from multiple points of view on the portable handheld traffic control device 100.

FIG. 25 shows a back view of a portable handheld traffic control device 100 including a mobile device 2300 arranged in a landscape orientation.

FIG. 26 shows a back view of a portable handheld traffic control device 100 including a mobile device 2300 arranged in a portrait orientation.

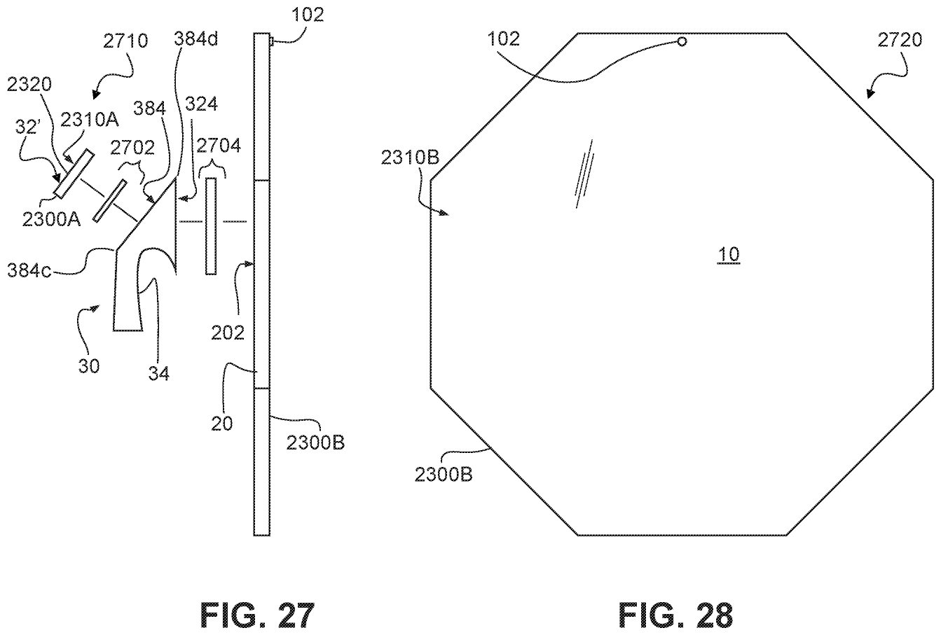

FIG. 27 shows an exploded side view of a portable handheld traffic control device 100 including a handle 30, a first mobile device 2300A, and a second mobile device 2300B.

FIG. 28 shows a front view of a portable handheld traffic control device 100 consistent with the embodiment shown in FIG. 27, including a second mobile device 2300B. As shown in FIG. 28, the second mobile device 2300B has a substantially octagonal shape. In other embodiments, the mobile device 2300B has another shape, for example, circle, oblong, rectangle, triangle, etc.

In accordance with embodiments as shown in FIGS. 27 and 28, the first mobile device 2300A provides a mobile UI 2310A, for example, corresponding to the mobile UI 2310 shown in FIG. 23, whereby a user may operate the portable handheld traffic control device 100 while grasping the grip portion 34 of the handle 30. In embodiments of the portable handheld traffic control device 100, including those shown in FIGS. 27 and 28, the second mobile device 2300B comprises the lamp 10. Thus, in some embodiments, the first mobile device 2300A acts as a control interface device 2710 and the second mobile device 2300B acts as a display device 2720. The second mobile device 2300B includes a lamp housing 20. The lamp housing 20 may be a component of the second mobile device 2300B, such as a frame, shell, or body of the second mobile device 2300B.

In various embodiments, as the user manipulates a software control panel 32′ provided on the first mobile device 2300A, a state of the lamp 10 provided on the second mobile device 2300B is adjusted in response to user input. In some embodiments, the second mobile device 2300B includes a mobile UI 2310B. As will be readily understood, in some embodiments, the second mobile UI 2310B includes user interface elements by which various aspects of the operation of the portable handheld traffic control device 100 may be configured. For example, in some embodiments, the second mobile UI 2310B includes a control panel interface by which a user may configure the second mobile device 2300B to communicate with the first mobile device 2300A. In various embodiments, communication between the first mobile device 2300A and the second mobile device 2300B is by wired, radio, wireless, near-field communication (NFC), optical, or any other appropriate transmission means.

In some embodiments, the first mobile device 2300A provides a secondary display, analogous to the feedback window 60 (see, e.g., FIG. 5). That is, in some embodiments, the first mobile device 2300A displays to the user a representation of a signal simultaneously displayed by the lamp 10 of the second mobile device 2300B.

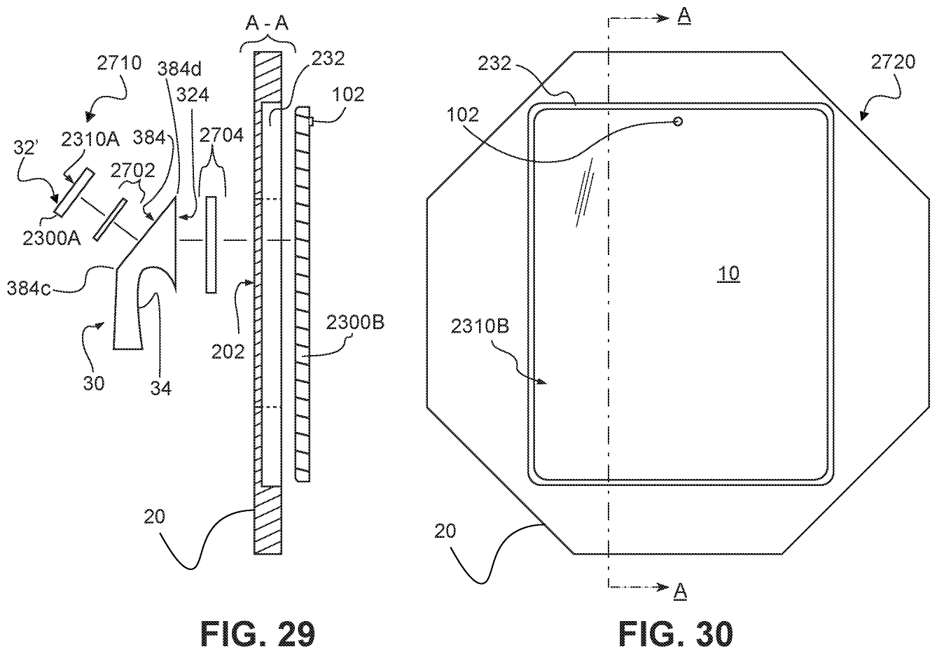

Referring to FIG. 27, the handle 30 includes a display support surface 324. In some embodiments, the display support surface 324 comprises one or both of a primary attachment portion 322 and a secondary attachment portion 362. (See, e.g., FIGS. 9 and 40.) When assembled together with a display device 2720, such as the second mobile device 2300B, the display support surface 324 extends from an edge of the grip portion 34 toward the proximal side 202 of the lamp housing 20 of the second mobile device 2300B. A display attachment device 2704 fixedly connects the display support surface 324 of the handle 30 to the second mobile device 2300B. According to various embodiments, the display attachment device 2704 includes one or more attachment means, including, but not limited to a fastener, a snap fit, a strap, a buckle, a clip, a hook-and-loop fastener, an adhesive, a magnet, or an elastic coupling. In some embodiments, the display attachment device 2704 as shown in FIGS. 27 and 29 has a positive thickness, such that the display attachment portion 324 of the handle 30 is not in direct contact with the second mobile device 2300B when the display attachment device 2704 fixes the display attachment portion 324 to the second mobile device 2300B. In other embodiments, the display attachment portion 324 of the handle 30 directly contacts the second mobile device 2300B when the display attachment device 2704 fixes the display attachment portion 324 to the second mobile device 2300B.

Still referring to FIG. 27, the handle 30 includes control panel support surface 384. In some embodiments, the control panel support surface 384 is situated at an intersection of the display attachment portion 324 and a grip portion 34 of the handle 30. A control panel attachment device 2702 fixedly connects the control panel support surface 384 of the handle 30 to the first mobile device 2300A. According to various embodiments, the control panel attachment device 2702 includes one or more attachment means, including, but not limited to a fastener, a snap fit, a strap, a buckle, a clip, a hook-and-loop fastener, an adhesive, a magnet, or an elastic coupling. In some embodiments, the control panel attachment device 2702 as shown in FIGS. 27 and 29 has a positive thickness, such that the control panel support surface 384 of the handle 30 is not in direct contact with the first mobile device 2300A when the control panel attachment device 2702 fixes the control panel support surface 384 to the first mobile device 2300A. In other embodiments, the control panel support surface 384 of the handle 30 directly contacts the first mobile device 2300A when the control panel attachment device 2702 fixes the control panel support surface 384 to the first mobile device 2300A.

In still other embodiments, a portable handheld traffic control device 100 includes a control panel 32 having manual interface elements (e.g., manual interface elements 302, 304, 306R, 306Y, 306G, 308L, 308R, 808C, 802) and a second mobile device 2300B that acts as a display device 2720. Thus, according to some embodiments, the second mobile device 2300B is controllable by manual interface elements on a control panel 32.

FIG. 29 shows an exploded partial cutaway side view of a portable handheld traffic control device 100 including a handle 30, a first mobile device 2300A, a housing 20, and a second mobile device 2300B according to another embodiment.

FIG. 30 shows a front view of a housing 20 and a second mobile device 2300B consistent with the embodiment shown in FIG. 29.

As shown in FIGS. 29 and 30, according to some embodiments, the handle 30 is attached to a housing 20, either directly or indirectly. For example, a display attachment device 2704 may be used to connect the handle 30 to the housing 20. In other embodiments, the handle 30 and the housing 20 are formed as a single piece.

In FIG. 29, the cutaway view A-A corresponds to the section view indicated in FIG. 30. In some embodiments, the housing 20 includes a mobile device receiving portion 232. Thus, although the housing 20 may have a first shape, such as an octagon, as shown in FIG. 30, the receiving portion 232 of the housing 20 may accommodate a display device 2720 having a second shape, for example, circle, oblong, rectangle, triangle, etc., different from the shape of the housing 20. For example, as shown in FIG. 30, the housing 20 has a substantially octagonal shape and the receiving portion 232 of the housing 20 has a substantially rectangular shape. The lamp 10 is part of the second mobile device 2300B, and the receiving portion 232 of the housing 20 accommodates the second mobile device 2300B, so that the second mobile device 2300B is operable as a display device 2720, while the front profile of the portable handheld traffic control device 100 has a shape covering an area substantially greater than the front profile of the second mobile device 2300B.

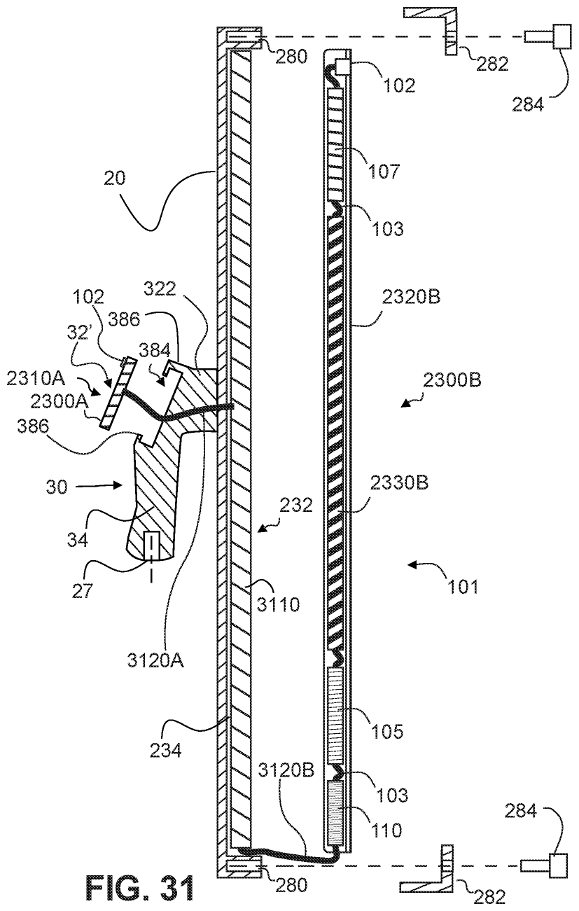

FIG. 31 shows an exploded cutaway side view of a portable handheld traffic control device 100 according to another embodiment. The portable handheld traffic control device 100 includes a housing 20, a handle 30 fixed to the housing 20, and a backup battery 3110. A first mobile device 2300A attaches to the handle 30. A second mobile device 2300B attaches to the housing 20. The handle 30 attaches to the housing 20 at a primary attachment portion 322. The handle 30 includes a control panel support surface 384 having opposing detents 386, whereby the first mobile device 2300A is fixed to the handle 30 at an intersection between a grip portion 34 of the handle 30 and the primary attachment portion 322 of the handle 30. The backup battery 3110 is disposed in a battery accommodating portion 234 of the housing 20. The housing 20 includes a mobile device receiving portion 232, in which the second mobile device 2300B is accommodated when assembled together with the housing 20. The housing 20 includes holes 280 for receiving threaded portions of screws 284, whereby one or more retainers 282 may be attached to secure the second mobile device 2300B to the housing 20. In other embodiments, other attachment devices are used to secure the second mobile device 2300B to the housing 20. Non-limiting examples of attachment devices include clamps, nuts and bolts, clips, detents, hook-and-loop fasteners, pressure-sensitive adhesives, and the like.

The portable handheld traffic control device 100 as shown in FIG. 31 includes a first backup battery connector 3120A that provides electricity from the backup battery 3110 to the first mobile device 2300A. The portable handheld traffic control device 100 likewise includes a second backup battery connector 3120B that provides electricity from the backup battery 3110 to the second mobile device 2300B. Thus, in some embodiments, a run time of the portable handheld traffic control device 100 is increased by charging at least one of the first and second mobile devices 2300A, 2300B via the backup battery 3110. For example, the second mobile device 2300B includes an internal battery 2330B, connectable to the backup battery 3110 via the second backup battery connector 3120B, which may be connected to the second mobile device 2300B, for example via a dedicated power jack, a serial port, a parallel port, or the like. Internal components of the second mobile device 2300B may include any of the elements of a computer 101, as discussed with respect to FIG. 13. In some embodiments, electric charge is transferred from the backup battery 3110 to the internal battery 2330B via wireless charging, e.g., by induction. Thus, in some embodiments, the second backup battery connector 3120B does not rely on a physical conductor to transfer electric charge. It will be readily understood that an internal battery of the first mobile device 2300A likewise may be configured and may operate in substantially the same manner as discussed with respect to the internal battery 2330B of the second mobile device 2300B, or in another manner already known, or developed hereafter.

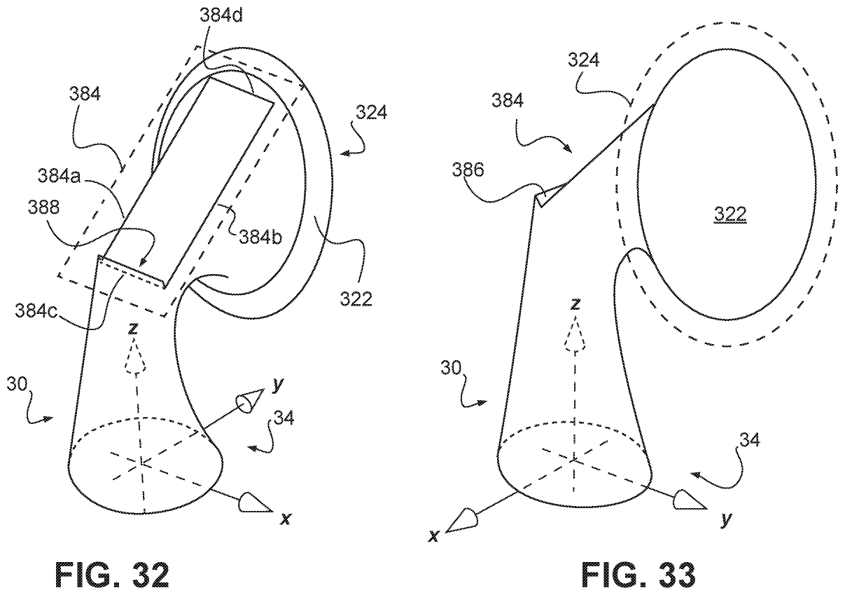

FIG. 32 shows a perspective view of a handle 30 in accordance with another embodiment.

FIG. 33 shows another perspective view of a handle 30 consistent with the embodiment shown in FIG. 32.

The handle 30 has a grip portion 34 around which one or more fingers of a user's hand may curve when holding the handle 30. The grip portion 34 is on a proximal end of the handle 30 (toward the user when in use). The handle 30 has a primary attachment portion 322 on a distal end of the handle 30 (away from the user when in use). The primary attachment portion 322 has a display support surface 324. The handle 30 has a control panel support surface 384.

The control panel support surface 384 is positioned in relation to the grip portion 34 such that the control panel support surface 384 is proximal to a user's thumb when the user's hand grasps the handle 30. The control panel support surface 384 permits a control interface device 2710, such as a first mobile device 2300A, to be manipulated by the user's thumb when the control interface device 2710 is installed on the handle 30. The display support surface 324 permits a display device 2720, such as a second mobile device 2300B, to emit light away from the user when the display device 2720 is installed on the handle 30.

In some embodiments, the display support surface 324 is configured to engage with a second mobile device 2300B. For example, as shown in FIGS. 32 and 33, the display support surface 324 has a substantially planar face against which a housing 20 of a lamp 10 may be mounted. In various embodiments, means for attaching a display device 2720—such as the second mobile device 2300B—to the handle 30, include various display attachment devices 2704, such as those discussed with respect to FIGS. 27 and 29.

In some embodiments, the control panel support surface 384 is configured to engage with a control interface device 2710, namely a first mobile device 2300A. For example, as shown in FIGS. 32 and 33, the handle 30 includes a ledge 388 along the proximal edge 384c of the control panel support surface 384. In another embodiment, as shown in FIG. 31, the handle 30 includes opposing detents 386 along the proximal edge 384c and distal edge 384d of the control panel support surface 384. More generally, means for attaching a control interface device 2710 to the handle 30 include various control panel attachment devices 2702, such as those discussed with respect to FIGS. 27 and 29.

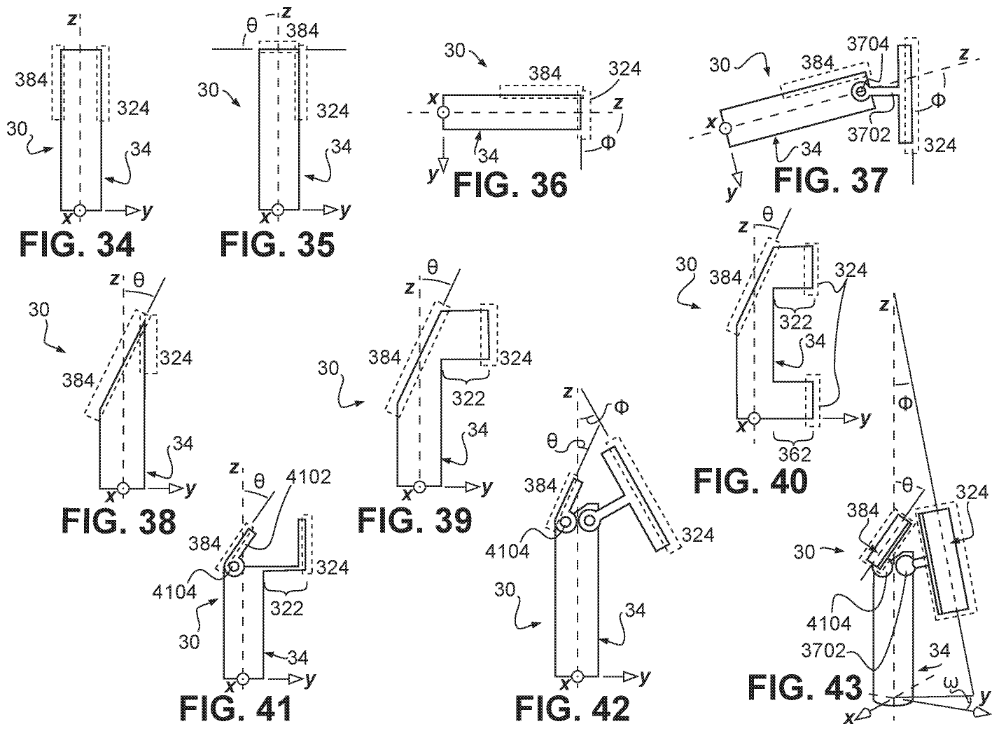

FIG. 34 shows a side view of a device according to an embodiment. A handle 30 has a grip portion 34 that extends along a longitudinal axis z. The handle 30 includes a control panel support surface 384 on a proximal side of the handle 30 and a display support surface 324 on a distal side of the handle 30. The control panel support surface 384 is parallel to the longitudinal axis z. The display panel support surface is parallel to the longitudinal axis z.

FIG. 35 shows a side view of a device according to an embodiment. A handle 30 has a grip portion 34 that extends along a longitudinal axis z. The handle 30 includes a control panel support surface 384 on a proximal side of the handle 30. In particular, the control panel support surface 384 extends in the negative-y direction. The handle 30 includes a display support surface 324 on a distal side of the handle 30. The control panel support surface 384 forms an angle θ with the longitudinal axis z. In an embodiment, the angle θ is 90 degrees. The display support surface 324 is parallel to the longitudinal axis z.

FIG. 36 shows a side view of a device according to an embodiment. A handle 30 has a grip portion 34 that extends along a longitudinal axis z. The handle 30 includes a control panel support surface 384 on a proximal side of the handle 30. The handle 30 includes a display support surface 324 on a distal side of the handle 30. In particular, the display support surface 324 extends in the positive-y direction. The display support surface 324 forms an angle ϕ with the longitudinal axis z. In an embodiment, the angle ϕ is 90 degrees. In some embodiments, a user holds the handle 30 with the longitudinal axis z parallel to the horizon and the proximo-distal axis y pointing in the gravity-downward direction.

Still referring to FIG. 36, a display device 2720—such as the second mobile device 2310B—when connected to the display support surface 324, stands vertically, to present a signal to oncoming pedestrian or vehicular traffic, with the weight of the portable handheld traffic control device 100 resting on the fingers of the hand, the dorsal aspect of the fingers facing downward toward the ground.

FIG. 37 shows a side view of a device according to an embodiment. A handle 30 has a grip portion 34 that extends along a longitudinal axis z. The handle 30 includes a control panel support surface 384 on a proximal side of the handle 30 and an adjustable display support member 3702. The adjustable display support member 3702 is coupled to the grip portion 34 by a pivot point 3704. The adjustable display support member 3702 has a display support surface 324 that forms an angle ϕ with the longitudinal axis z. The angle ϕ can be varied by pivoting the adjustable display support member 3702 around the pivot point 3704.

Still referring to FIG. 37, a user grasping the grip portion 34 of the handle 30 may adjust the angle ϕ so that a display device 2720—such as the second mobile device 2310B—when connected to the display support surface 324, stands vertically, to present a signal to oncoming pedestrian or vehicular traffic, with the weight of the portable handheld traffic control device 100 resting on the fingers of the hand, the dorsal aspect of the fingers facing generally downward toward the ground.

In some embodiments, the weight of the portable handheld traffic control device 100 is balanced with a center where the grip portion 34 contacts a user's hand. More particularly, according to some embodiments, the handheld traffic control device 100 rests on an anterior surface of the user's finger or fingers without application of pressure against the grip portion 34 by the user's palm. In other embodiments, the handheld traffic control device 100 rests on an anterior surface of the user's palm without application of pressure against the grip portion 34 by any of the user's fingers. In still other embodiments, the balance of forces acting on the handheld traffic control device 100 at rest includes gravity, at least one normal force of at least one of the user's fingers on the grip portion 34 and at least one opposing normal force of at least one portion of the palm of the user's hand on the grip portion 34.

FIG. 38 shows a side view of a device according to an embodiment. A handle 30 has a grip portion 34 that extends along a longitudinal axis z. The handle 30 includes a control panel support surface 384 on a proximal side of the handle 30. The handle 30 includes a display support surface 324 on a distal side of the handle 30. The control panel support surface 384 forms an angle θ with the longitudinal axis z. In an embodiment, the angle θ is 20 degrees. In other embodiments, the angle θ is from 0 to 30 degrees, from 15 to 45 degrees, from 30 to 60 degrees, from 45 to 75 degrees, or from 60 to 90 degrees.

FIG. 39 shows a side view of a device according to an embodiment. A handle 30 has a grip portion 34 that extends along a longitudinal axis z. The handle 30 includes a control panel support surface 384 on a proximal side of the handle 30. The handle 30 includes a display support surface 324 on a distal side of the handle 30. The control panel support surface 384 forms an angle θ with the longitudinal axis z. In an embodiment, the angle θ is 22.5 degrees. In other embodiments, the angle θ is from 0 to 30 degrees, from 15 to 45 degrees, from 30 to 60 degrees, from 45 to 75 degrees, or from 60 to 90 degrees. The handle 30 includes an attachment portion 322 that extends from the distal side of the grip portion 34 so that the display support surface 324 is spaced apart distally from the grip portion 34. According to various embodiments, the attachment portion 322 ensures sufficient space to accommodate the fingers of a hand grasping the grip portion 34 without impinging on a display device 2710 when the display device 2710 is attached to display support surface 324.

FIG. 40 shows a side view of a device according to an embodiment. A handle 30 has a grip portion 34 that extends along a longitudinal axis z. The handle 30 includes a control panel support surface 384 on a proximal side of the handle 30. The handle 30 includes a display support surface 324 on a distal side of the handle 30. The control panel support surface 384 forms an angle θ with the longitudinal axis z. In an embodiment, the angle θ is 22.5 degrees. In other embodiments, the angle θ is from 0 to 30 degrees, from 15 to 45 degrees, from 30 to 60 degrees, from 45 to 75 degrees, or from 60 to 90 degrees. The handle 30 includes a primary attachment portion 322 and a secondary attachment portion 362. The display support surface 324 includes distal surfaces of both the primary attachment portion 322 and the secondary attachment portion 362. The display support surface 324 is spaced apart distally from the grip portion 34 by the primary and secondary attachment portions 322 and 362. According to various embodiments, the attachment portions 322 and 362 ensure sufficient space to accommodate the fingers of a hand grasping the grip portion 34 without impinging on a display device 2710 when the display device 2710 is attached to the display support surface 324.

FIG. 41 shows a side view of a device according to an embodiment. A handle 30 has a grip portion 34 that extends along a longitudinal axis z. The handle 30 includes an adjustable control panel support member 4102. The adjustable control panel support member 4102 is coupled to the grip portion 34 by a pivot point 4104. The adjustable control panel support member 4102 has a control panel support surface 384 that forms an angle θ with the longitudinal axis z. The angle θ can be varied by pivoting the adjustable control panel support member 4102 around the pivot point 4104. The handle 30 includes an attachment portion 322. The display support surface 324 includes a distal surface of the attachment portion 322, such that the display support surface 324 is spaced apart distally from the grip portion 34 by the attachment portion 322.

FIG. 42 shows a side view of a device according to an embodiment. A handle 30 has a grip portion 34 that extends along a longitudinal axis z. The handle 30 includes an adjustable control panel support member 4102. The adjustable control panel support member 4102 is coupled to the grip portion 34 by a pivot point 4104. The adjustable control panel support member 4102 has a control panel support surface 384 that forms an θ with the longitudinal axis z. The θ can be varied by pivoting the adjustable control panel support member 4102 around the pivot point 4104. The handle 30 includes an adjustable display support member 3702. The adjustable display support member 3702 is coupled to the grip portion 34 by a pivot point 3704. The adjustable display support member 3702 has a display support surface 324 that forms an ϕ with the longitudinal axis z. The ϕ can be varied by pivoting the adjustable display support member 3702 around the pivot point 3704.

FIG. 43 shows a perspective view of a device according to an embodiment. A handle 30 has a grip portion 34 that extends along a longitudinal axis z. The handle 30 includes an adjustable control panel support member 4102. The adjustable control panel support member 4102 is coupled to the grip portion 34 by a control panel support pivot point 4104. The adjustable control panel support member 4102 has a control panel support surface 384 that forms an θ with the longitudinal axis z. The θ can be varied by pivoting the adjustable control panel support member 4102 around the control panel support pivot point 4104. In some embodiments, the pivot point 4104 is adjustable in more than a single degree of freedom. For example, the control panel support pivot point 4104 may include a ball-and-socket joint whereby the control panel support member 4102 is rotatable to vary a yaw, pitch, and roll of the control panel support member 4102 with respect to the handle 30.

Still referring to FIG. 43, the handle 30 includes an adjustable display support member 3702. The adjustable display support member 3702 is coupled to the grip portion 34 by a pivot point 3704. In some embodiments, the pivot point 3704 is adjustable in more than a single degree of freedom. For example, the pivot point 3704 may include a ball-and-socket joint whereby the display support member 3702 is rotatable to vary a yaw, pitch, and roll of the display support member 3702 with respect to the handle 30. The adjustable display support member 3702 has a display support surface 324 that forms an ϕ with the longitudinal axis z. The ϕ can be varied by pivoting the adjustable display support member 3702 around the pivot point 3704. As shown in FIG. 43, the display support surface 324 also forms an ω with the proximo-distal axis y. The ω can be varied by pivoting the adjustable display support member 3702 around the pivot point 3704.

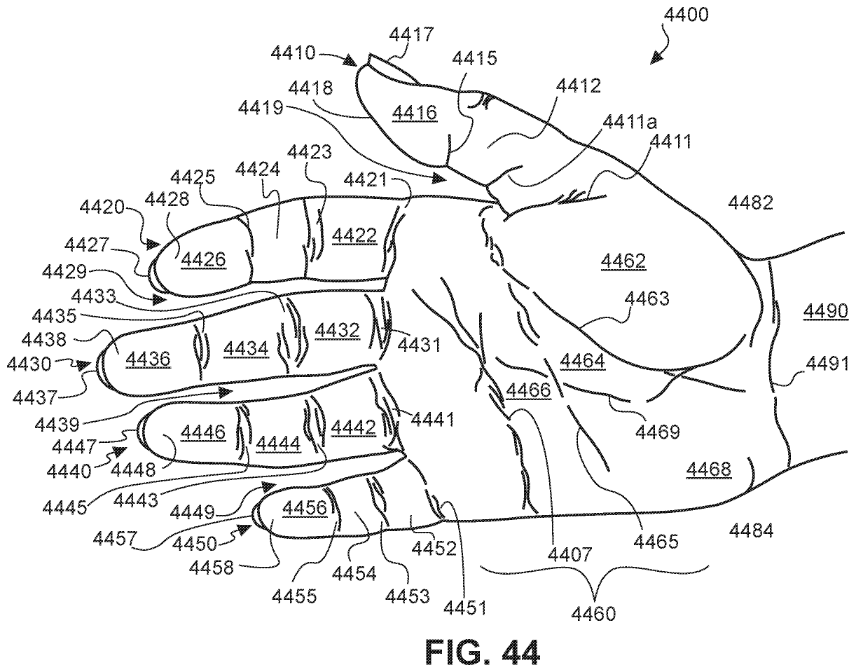

FIG. 44 shows a palmar (anterior) aspect of a right hand 4400. The hand 4400 has five digits including a thumb 4410, an index finger 4420, a middle finger 4430, a ring finger 4440, and a small finger 4450. When the hand 4400 is open with the digits spread apart, a first interdigital space 4419 separates the thumb 4410 from the index finger 4420; a second interdigital space 4429 separates the index finger 4420 from the middle finger 4430; a third interdigital space 4439 separates the middle finger 4430 from the ring finger 4440; and a fourth interdigital space 4449 separates the ring finger 4440 from the small finger 4450.

Various portions of the anterior surface of the hand 4400 are discernable based on creases or folds in the epidermis (the outermost layer of skin) of the hand 4400. The thumb 4410 is on a radial side 4482 of the hand 4400 and the small finger 4450 is on an ulnar side 4484 of the hand 4400. Proceeding from the radial side 4482 toward the ulnar side 4484, a palm 4460 of the hand 4400 has a thenar region 4462, a median palmar region 4464, a palmar region 4466, and a hypothenar region 4468. The thenar region 4462 adjoins the thumb 4410 on the radial side 4482 of the hand 4400. The hypothenar region 4408 adjoins the ulnar side 4484, opposite the thenar region 4462. A thenar crease 4463 is between the thenar region 4462 and the median palmar region 4464. A proximal palmar crease 4465 is between the median palmar region 4464 and the palmar region 4466. A distal palmar crease 4467 is between the palmar region 4466 and the three fingers (4430, 4440, 4450) nearest the ulnar side 4484 of the hand 4400. A distal wrist crease 4491 is near where a wrist 4490 joins the hand 4400.

The thumb 4410 has a proximal phalanx 4412 and a distal phalanx 4416, with a distal interphalangeal joint crease 4415 between them. A thumb nail 4417 is on the dorsal (posterior) side of the distal phalanx 4416, and a tip 4418 of the thumb 4410 is on the palmar (anterior) side, opposite the thumb nail 4417.

Each of the fingers (4420, 4430, 4440, and 4450) has a proximal phalanx (4422, 4432, 4442, 4452, respectively), a middle phalanx (4424, 4434, 4444, 4454, respectively), and a distal phalanx (4426, 4436, 4446, 4456, respectively) with a finger nail (4427, 4437, 4447, 4457, respectively) on the dorsal (posterior) side and, opposite the corresponding nail, a tip (4428, 4438, 4448 4458, respectively) on the palmar (anterior) side. Between the palmar region 4406 and the respective proximal phalanges (4411, 4422, 4432, 4442, 4452) of the digits (4410, 4420, 4430, 4440, 4450) are respective palmar digital joint creases (4411, 4421, 4431, 4441, and 4451). The thumb 4410 has an accessory crease 4411a. Each of the fingers (4420, 4430, 4440, 4450) has a proximal interphalangeal joint crease (4423, 4433, 4443, 4453, respectively) between the corresponding proximal phalanges (4422, 4432, 4442, 4452) and middle phalanges (4424, 4434, 4444, 4454). Each of the fingers (4420, 4430, 4440, 4450) has a distal interphalangeal joint crease (4425, 4435, 4445, 4455) between the corresponding middle phalanges (4424, 4434, 4444, 4454) and distal phalanges (4426, 4436, 4446, 4456). The thumb 4410 has a distal interphalangeal joint crease 4415 between the proximal phalanx 4412 and the distal phalanx 4416.

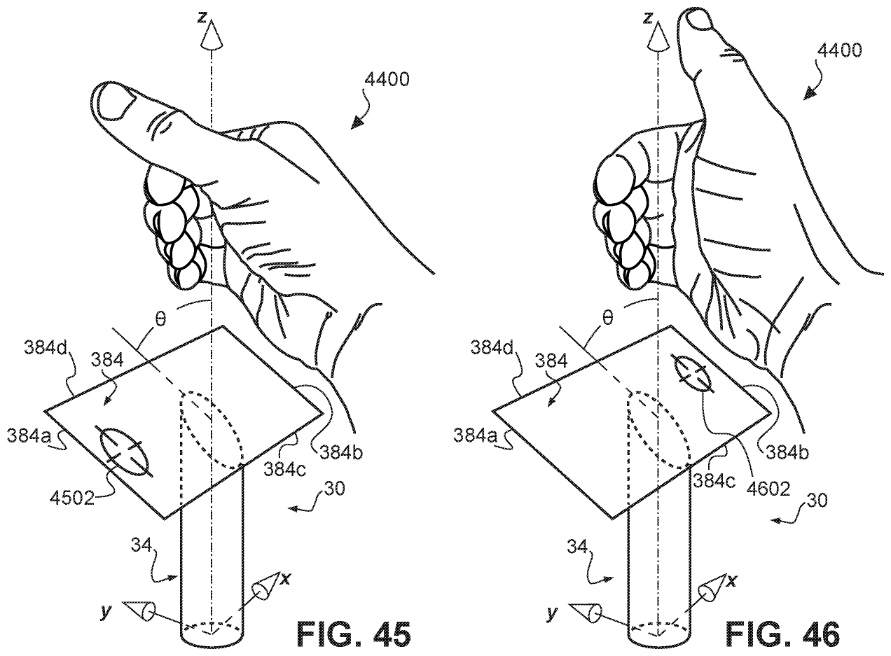

FIG. 45 shows a perspective view of a hand 4400 arranged to grasp a handle 30 in use, except that for clarity of illustration, the handle 30 is shown translated apart from the hand 4400 along the z-axis. In FIG. 45, the fingers (4420, 4430, 4440, 4460) are bent in flexion so that one or more anterior regions of the phalanges (4422, 4424, 4426; 4432, 4434, 4436; 4442, 4444, 4446; 4452, 4454, 4456) presses against the grip portion 34 on the distal side of the handle 30, and the palm 4460—including one or more of the thenar region 4402, the median palmar region 4404, the palmar region 4406, and the hypothenar region 4408—presses back against the grip portion 34 on the proximal side of the handle 30. Thus, it is possible for a user to grasp the handle 30 using portions of the hand 4400 other than the thumb 4410. In some embodiments, when the handle 30 is in use, a control interface device 2710, such as a first mobile device 2300A, may be attached to the control panel support surface 384. Where at least one of the control panel support surface 384 and the control interface device 2710 extends laterally beyond the grip portion 34, one or both of the control panel support surface 384 and the control interface device 2710 may occupy the first interdigital space 4419.

FIG. 45 shows the handle 30 having a control panel support surface 384 at an angle θ relative to the z-axis. In some embodiments, the control panel support surface 384 comprises a planar surface. In other embodiments, the control panel support surface 384 has surfaces of other shapes, such as arcuate, convex, or concave.

In FIG. 45, the thumb 4410 is abducted away from the palm 4460 so that the tip 4418 of the thumb 4410 aligns with the crosshairs 4502, toward the anterior (medial) edge 384a of the control panel support surface 384. When a control interface device 2710 is connected to the control panel support surface 384, the tip 4418 of the thumb 4410 may be brought into contact with the control interface device 2710 at a position corresponding to the crosshairs 4502.

FIG. 46 shows an embodiment consistent with that shown in FIG. 45. In FIG. 46, the thumb 4410 is adducted into alignment with the palm 4460 of the hand 4400 so that the tip 4418 of the thumb 4410 aligns with the crosshairs 4602 at a position toward the posterior (lateral) edge 384b of the control panel support surface 384 when brought into contact with a control interface device 2710 on the control panel support surface 384. When a control interface device 2710 is connected to the control panel support surface 384, the tip 4418 of the thumb 4410 may be brought into contact with the control interface device 2710 at a position corresponding to the crosshairs 4602.

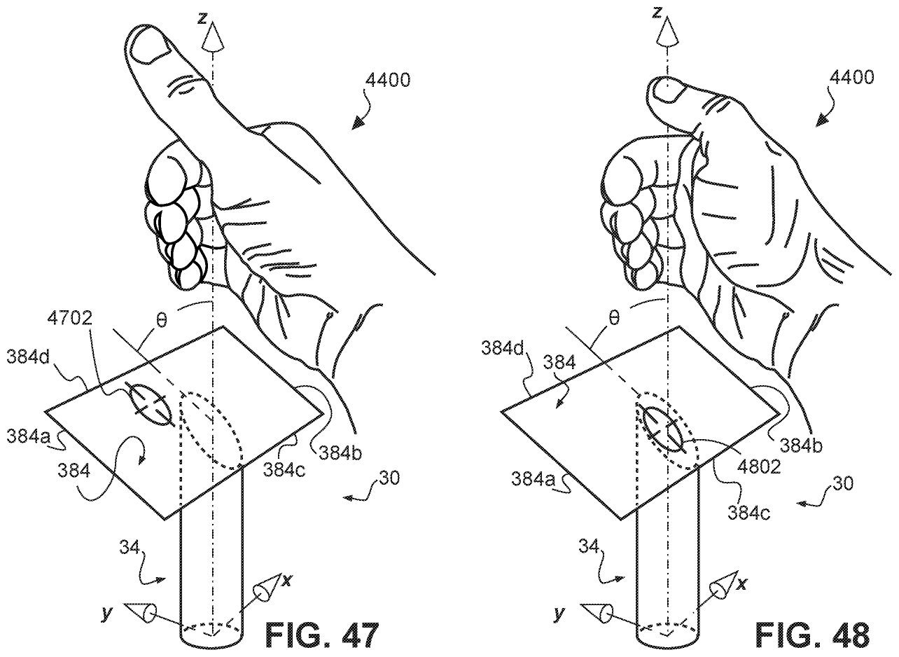

FIG. 47 shows an embodiment consistent with those shown in FIGS. 45 and 46. In FIG. 47, the thumb 4410 is extended forward so that the tip 4418 of the thumb 4410 aligns with the crosshairs 4702 at a position toward the distal edge 384d of the control panel support surface 384. When a control interface device 2710 is connected to the control panel support surface 384, the tip 4418 of the thumb 4410 may be brought into contact with the control interface device 2710 at a position corresponding to the crosshairs 4702.

FIG. 48 shows an embodiment consistent with those shown in FIGS. 45, 46, and 47. In FIG. 48, the thumb 4410 is flexed backward so that the tip 4418 of the thumb 4410 aligns with the crosshairs 4802 at a position toward the proximal edge 384c of the control panel support surface 384. When a control interface device 2710 is connected to the control panel support surface 384, the tip 4418 of the thumb 4410 may be brought into contact with the control interface device 2710 at a position corresponding to the crosshairs 4802.

Thus, it is possible for a user to manipulate a control interface device 2710 using the tip 4418 of the thumb 4410.

In some embodiments, the positions of the thumb 4400 shown in FIGS. 45 (abduction), 46 (adduction), 47 (extension), and 48 (flexion) define limits of a range of motion of the tip 4418 of the thumb 4410 relative to the control panel support surface 384. That is, in some embodiments, the tip 4418 of the thumb 4410 may occupy the positions corresponding to the crosshairs 4502, 4602, 4702, 4802, and any number of positions intermediate to the same. In some embodiments, the positions of the crosshairs 4502, 4602, 4702, 4802, correspond to limits of a comfortable range of motion of the tip 4418 of the thumb 4400 relative to the control panel support surface 384. In some embodiments, the thumb 4410 may occupy various other positions beyond those shown in FIGS. 45, 46, 47, and 48.

Some embodiments include determining a range of motion of the thumb 4410 and adjusting a position of the control interface device 2710 to correspond to the range of motion of the thumb 4410. Some embodiments include determining a range of motion of the thumb 4410 and adjusting a size of the control interface device 2710 to correspond to the range of motion of the thumb 4410.

In some embodiments, a control interface device 2710 includes one or more manual interface elements (e.g., 302, 304, 306R, 306Y, 306G, 308L, 308R, 808C, 802), one or more touchscreen interface elements (e.g., 302′, 304′, 306R′, 306Y′, 306G′, 308L′, 308R′, 808′, 802′), or a combination of manual interface elements and touchscreen interface elements. Some embodiments include determining a range of motion of the thumb 4410 and arranging one or more interface elements of the control interface device 2710 to fit within the range of motion of the thumb 4410. In some embodiments, the arranging the one or more interface elements of the control interface device 2710 includes adjusting a position of a touchscreen interface element of a mobile UI 2310. In some embodiments, the arranging the one or more interface elements of the control interface device 2710 includes adjusting a size of a touchscreen interface element of a mobile UI 2310.

Unless the context clearly dictates otherwise and where a range of values is provided, it is understood that each intervening value, to the tenth of the unit of the lower limit, between the upper and lower limit of that range, and any other stated or intervening value in that stated range is encompassed within the technology. The upper and lower limits of these intervening ranges, which may be independently included in the intervening ranges, are also encompassed within the technology, subject to any specifically excluded limit in the stated range. Where the stated range includes one or both of the limits, ranges excluding either or both of those included limits are also included in the technology.

Furthermore, where a value or values are stated herein as being implemented as part of the technology, it is understood that such values may be approximated, unless otherwise stated, and such values may be utilized to any suitable significant digit to the extent that a practical technical implementation may permit or require it.

Unless defined otherwise, all technical and scientific terms used herein have the same meaning as commonly understood by one of ordinary skill in the art to which this technology belongs. Although any methods and materials similar or equivalent to those described herein can also be used in the practice or testing of the present technology, a limited number of the exemplary methods and materials are described herein.

When a particular material is identified as being preferably used to construct a component, obvious alternative materials with similar properties may be used as a substitute. Furthermore, unless specified to the contrary, any and all components herein described are understood to be capable of being manufactured and, as such, may be manufactured together or separately.

It must be noted that as used herein and in the appended claims, the singular forms “a”, “an”, and “the” include their plural equivalents, unless the context clearly dictates otherwise.

All publications mentioned herein are incorporated by reference to disclose and describe the methods and/or materials which are the subject of those publications.

Moreover, in interpreting the disclosure, all terms should be interpreted in the broadest reasonable manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The subject headings used in the detailed description are included only for the ease of reference of the reader and should not be used to limit the subject matter found throughout the disclosure or the claims. The subject headings should not be used in construing the scope of the claims or the claim limitations.

Although the technology herein has been described with reference to particular embodiments, it is to be understood that these embodiments are merely illustrative of the principles and applications of the technology. In some instances, the terminology and symbols may imply specific details that are not required to practice the technology. For example, although the terms “first” and “second” may be used, unless otherwise specified, they are not intended to indicate any order but may be utilized to distinguish between distinct elements. Furthermore, although process steps in the methodologies may be described or illustrated in an order, such an ordering is not required. Those skilled in the art will recognize that such ordering may be modified and/or aspects thereof may be conducted concurrently or even synchronously.

It is therefore to be understood that numerous modifications may be made to the illustrative embodiments and that other arrangements may be devised without departing from the spirit and scope of the technology.

1. A handle for a portable handheld traffic control device, the handle comprising:
a grip portion that extends along an axis;
a control panel support surface on a proximal side of the handle;
a display support surface on a distal side of the handle; and
a control panel attachment device to removably connect a control interface device to the control panel support surface such that the control interface device, when connected to the control panel support surface, is operable by a thumb of a hand that, when the handle is in use, grasps the grip portion by at least one of a finger and a palm of the hand.

2. A portable handheld traffic control device, comprising:
the handle of claim 1; and
a control interface device connected to the control panel support surface.

3. The portable handheld traffic control device of claim 2, wherein the control interface device includes a mobile device having a touchscreen.

4. The portable handheld traffic control device of claim 2, further comprising:
a display device connected to the display support surface.

5. The portable handheld traffic control device of claim 4, wherein the display device includes a second mobile device having a touchscreen.

6. The portable handheld traffic control device of claim 4, further comprising:
a communication channel between the control interface device and the display device, the communication channel being configured such that the control interface device is configured to communicate via the communication channel to control a signal presented by a lamp of the display device, and the display device is configured to communicate via the communication channel to control a secondary display of the control interface device.

7. The portable handheld traffic control device of claim 6, wherein the secondary display of the control interface device is configured to display a representation of a signal simultaneously displayed by the lamp of the display device.

8. The handle of claim 1, further comprising:
a display attachment device to removably connect a display device to the display support surface.

9. A portable handheld traffic control device, comprising:
the handle of claim 8; and
a display device connected to the display support surface.

10. A portable handheld traffic control device, comprising:
the handle of claim 1;
a control interface device connected to the control panel support surface; and
a display device connected to the display support surface.

11. The handle of claim 1, wherein the control panel support surface is parallel to the longitudinal axis of the grip portion.

12. The handle of claim 1, wherein the control panel support surface is angled relative to the longitudinal axis of the grip portion.

13. The handle of claim 1, further comprising:
an adjustable display support member connected to the handle at a pivot point, the display support surface including a distal face of the display support member, whereby an angle of the display support surface relative to the longitudinal axis of the grip portion is variable by pivoting the display support member about the pivot point.

14. A handle for a portable handheld traffic control device, the handle comprising:
a grip portion that extends along an axis;
a control panel operable by a thumb of a hand that, when the handle is in use, grasps the grip portion between at least one finger and the palm of the hand;
a display support surface on a distal side of the handle; and
a display attachment device to removably connect a display device to the display support surface.

15. A portable handheld traffic control device, comprising:
the handle of claim 14; and
a display device connected to the display support surface.

16. The portable handheld traffic control device of claim 15, wherein the display device includes a second mobile device having a touchscreen.

17. A method of signaling to oncoming traffic, the method comprising:
grasping a grip portion of a portable handheld traffic control device between at least one finger and a palm of a hand, the portable handheld traffic control device including a control interface device having a plurality of interface elements; and, while grasping the grip portion between the finger and palm:
abducting the thumb of the hand away from the palm to contact an interface element positioned toward a medial edge of the control interface device;
adducting the thumb of the hand to contact an interface element positioned toward a lateral edge of the control interface device;
extending the thumb of the hand to contact an interface element positioned toward a distal edge of the control interface device; and
flexing the thumb of the hand to contact an interface element positioned toward a proximal edge of the control interface device.

18. The method of claim 17, wherein the plurality of interface elements includes at least one manual interface element.

19. The method of claim 17, wherein the plurality of interface elements includes at least one touchscreen interface element.

20. The method of claim 19, wherein the control interface device includes a touchscreen of a mobile device, the method further comprising:
displaying the touchscreen interface element on the touchscreen of the mobile device.
